(19) United States
(12) Patent Application Publication
(10) Pub. No.: US 2026/0303274 A1
(43) Pub. Date: Oct. 1, 2026

(54) COLLISION HANDLING BETWEEN TRANSMISSIONS ASSOCIATED WITH CARRIER AGGREGATION AND SUBBAND FULL DUPLEX

(71) Applicant: QUALCOMM Incorporated, San Diego, CA (US)

(72) Inventors: Muhammad Sayed Khairy ABDELGHAFFAR, San Jose, CA (US); Qian ZHANG, Basking Ridge, NJ (US)

(21) Appl. No.: 19/564,464

(22) Filed: Mar. 12, 2026

Related U.S. Application Data
(60) Provisional application No. 63/778,511, filed on Mar. 27, 2025.

(51) Int. Cl. H04L 5/00; H04L 5/14; H04W 72/231; H04W 76/20

(52) U.S. Cl. CPC H04L 5/001; H04L 5/14; H04W 72/231; H04W 76/20

(57) ABSTRACT

Various aspects of the present disclosure generally relate to wireless communication. In some aspects, a user equipment (UE) may receive a configuration that indicates a plurality of component carriers (CCs) associated with carrier aggregation (CA), wherein the plurality of CCs includes a first CC associated with subband full duplex (SBFD) and a second CC associated with time division duplexing (TDD) or SBFD, and wherein the configuration is based at least in part on a UE capability support of a half-duplex mode among the plurality of CCs. The UE may perform a collision handling between a first transmission associated with the first CC and a second transmission associated with the second CC based at least in part on a set of collision handling rules. Numerous other aspects are described.

### CROSS-REFERENCE TO RELATED APPLICATION

This Patent Application claims priority to U.S. Provisional Patent Application No. 63/778,511, filed on Mar. 27, 2025, entitled “COLLISION HANDLING BETWEEN TRANSMISSIONS ASSOCIATED WITH CARRIER AGGREGATION AND SUBBAND FULL DUPLEX,” and assigned to the assignee hereof. The disclosure of the prior Application is considered part of and is incorporated by reference into this Patent Application.

### FIELD OF THE DISCLOSURE

Aspects of the present disclosure generally relate to wireless communication and specifically relate to techniques, apparatuses, and methods associated with collision handling between transmissions associated with carrier aggregation and subband full duplex.

### DESCRIPTION OF THE RELATED TECHNOLOGY

Wireless communication systems are widely deployed to provide various services, which may involve carrying or supporting voice, text, other messaging, video, data, or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, or device transmit power, among other examples). Such multiple-access RATs are supported by technological advancements that have been adopted in various telecommunication standards, which define common protocols that enable different wireless communication devices to communicate on a local, municipal, national, regional, or global level. An example telecommunication standard is New Radio (NR). NR, which also may be referred to as 5G, is part of a continuous mobile broadband evolution promulgated by the Third Generation Partnership Project (3GPP). As the demand for connectivity continues to increase, further improvements in NR may be implemented, and other RATs, such as 6G and beyond, may be introduced to enable new applications and facilitate new use cases.

### SUMMARY

The systems, methods, and devices of this disclosure each have several innovative aspects, no single one of which is solely responsible for the desirable attributes disclosed herein.

In some implementations, an apparatus for wireless communication at a user equipment (UE) includes one or more memories; and one or more processors, coupled to the one or more memories, configured to cause the UE to: receive a configuration that indicates a plurality of component carriers (CCs) associated with carrier aggregation (CA), wherein the plurality of CCs includes a first CC associated with subband full duplex (SBFD) and a second CC associated with time division duplexing (TDD) or SBFD, and wherein the configuration is based at least in part on a UE capability support of a half-duplex (HD) mode among the plurality of CCs; and perform a collision handling between a first transmission associated with the first CC and a second transmission associated with the second CC based at least in part on a set of collision handling rules.

In some implementations, an apparatus for wireless communication at a network node includes one or more memories; and one or more processors, coupled to the one or more memories, configured to cause the network node to: transmit a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and detect a collision handling between a first transmission associated with the first CC and a second transmission associated with the second CC based at least in part on a set of collision handling rules.

In some implementations, a method of wireless communication performed by a UE includes receiving a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and performing a collision handling between a first transmission associated with the first CC and a second transmission associated with the second CC based at least in part on a set of collision handling rules.

In some implementations, a method of wireless communication performed by a network node includes transmitting a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and detecting a collision handling between a first transmission associated with the first CC and a second transmission associated with the second CC based at least in part on a set of collision handling rules.

In some implementations, a non-transitory computer-readable medium storing a set of instructions for wireless communication includes one or more instructions that, when executed by one or more processors of a UE, cause the UE to: receive a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and perform a collision handling between a first transmission associated with the first CC and a second transmission associated with the second CC based at least in part on a set of collision handling rules.

In some implementations, a non-transitory computer-readable medium storing a set of instructions for wireless communication includes one or more instructions that, when executed by one or more processors of a network node, cause the network node to: transmit a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and detect a collision handling between a first transmission associated with the first CC and a second transmission associated with the second CC based at least in part on a set of collision handling rules.

In some implementations, an apparatus for wireless communication includes means for receiving a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and means for performing a collision handling between a first transmission associated with the first CC and a second transmission associated with the second CC based at least in part on a set of collision handling rules.

In some implementations, an apparatus for wireless communication includes means for transmitting a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and means for detecting a collision handling between a first transmission associated with the first CC and a second transmission associated with the second CC based at least in part on a set of collision handling rules.

Aspects of the present disclosure may generally be implemented by or as a method, apparatus, system, computer program product, non-transitory computer-readable medium, user equipment, network node, wireless communication device, or processing system as substantially described in the Detailed Description with reference to, and as illustrated by, the accompanying drawings. Details of one or more implementations of the subject matter described in this disclosure are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is a diagram illustrating an example of a wireless network.

FIG. 2 is a diagram illustrating an example disaggregated base station architecture.

FIG. 3 is a diagram illustrating examples of full duplex communications.

FIG. 4 is a diagram illustrating an example of conflicts across different component carriers in subband full duplex (SBFD) symbols.

FIGS. 5-11 are diagrams illustrating examples associated with collision handling between transmissions associated with carrier aggregation and SBFD.

FIG. 12 is a flowchart illustrating an example process performed, for example, by a user equipment.

FIG. 13 is a flowchart illustrating an example process performed, for example, by a network node.

FIGS. 14-15 are diagrams of example apparatuses for wireless communication.

### DETAILED DESCRIPTION

A full duplex (FD) operation may involve a subband full duplex (SBFD) operation, in which a transmission and a reception may occur at the same time but on different frequency resources. A downlink resource may be separated from an uplink resource in a frequency domain. In the SBFD operation, no downlink and uplink overlap in frequency may occur. The SBFD operation may imply a simultaneous transmit (Tx)/receive (Rx) (Tx/Rx) of downlink/uplink on a sub-band basis at a network node. A user equipment (UE) may still operate in a half-duplex (HD) mode (e.g., either receive or transmit at a given time). The SBFD operation may provide latency reduction by allowing a transmission of uplink channels/signals in an uplink subband in legacy downlink slots and a reception of downlink channels/signals in a downlink subband in legacy uplink slots. The SBFD operation may provide an uplink coverage enhancement. The SBFD operation may provide a flexible/dynamic uplink/downlink resource adaptation according to uplink/downlink traffic.

An SBFD operation may be within a carrier, and rules may be specified for handling a collision between conflict uplink/downlink transmissions in SBFD symbols. An SBFD-aware UE may be configured with a carrier aggregation (CA) operation (e.g., an intra-band or inter-band CA operation) where one or more component carriers (CCs) may be associated with an SBFD mode. However, an HD CA UE may not be configured to resolve conflicts (or collisions) across different CCs in SBFD symbols. Such conflicts may result in certain uplink/downlink transmissions across different CCs in SBFD symbols being dropped. For example, certain uplink/downlink transmissions that should be prioritized may be dropped, while certain uplink/downlink transmissions that should not be prioritized may be transmitted, which may degrade an overall system performance.

Various aspects relate generally to collision handling. Some aspects more specifically relate to collision handling between transmissions associated with CA and SBFD. In some examples, a UE (e.g., an HD CA UE) may receive, from a network node, a configuration that indicates a plurality of CCs associated with CA. The CA may be an intra-band CA or an inter-band CA. The plurality of CCs may include a first CC associated with SBFD and a second CC associated with time division duplexing (TDD) or SBFD. The UE may receive the configuration based at least in part on a UE capability support of an HD mode among the plurality of CCs, where the plurality of CCs may include SBFD CCs and TDD CCs (e.g., CCs associated with SBFD and CCs associated with TDD). The UE may perform a collision handling between a first transmission associated with the first CC and a second transmission associated with the second CC based at least in part on a set of collision handling rules. The UE, as part of the collision handling, may transmit the first transmission and drop the second transmission based at least in part on the set of collision handling rules. The UE, as part of the collision handling, may transmit the second transmission and drop the first transmission based at least in part on the set of collision handling rules. In one example, the first transmission may be an uplink transmission, the second transmission may be a downlink transmission, and the second CC may be associated with TDD or SBFD. In another example, the first transmission may be a downlink transmission, the second transmission may be an uplink transmission, and the second CC may be associated with SBFD. In some aspects, an uplink transmission from the UE may correspond to an uplink reception by the network node. In some aspects, a downlink transmission from the network node may correspond to a downlink reception by the UE.

Particular aspects of the subject matter described in this disclosure can be implemented to realize one or more of the following potential advantages. In some examples, by configuring the UE with the plurality of CCs associated with CC and by configuring the UE with the set of collision handling rules, the described techniques can be used by the UE to perform the collision handling between the first transmission associated with the first CC and the second transmission associated with the second CC based at least in part on the set of collision handling rules. The UE may be able to perform collision handling across multiple CCs, where at least one of the multiple CCs is associated with SBFD. The collision handling may be for SBFD with multiple CCs, as opposed to collision handling that is for SBFD and a single carrier. The collision handling may resolve uplink/downlink collisions across the multiple CCs. As a result, the UE may be able to perform collision handling across the plurality of CCs for HD CA with SBFD, thereby improving an overall system performance. 5G New Radio (NR) may support enhanced mobile broadband (eMBB) access, Internet of Things (IoT) networks or reduced capability (RedCap) device deployments, ultra-reliable low-latency communication (URLLC) applications, or massive machine-type communication (mMTC), among other examples. To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial or aerial platforms, among other examples.

The methods, operations, apparatuses, and techniques described herein may enable one or more of the foregoing technologies or new technologies or support one or more of the foregoing use cases or new use cases.

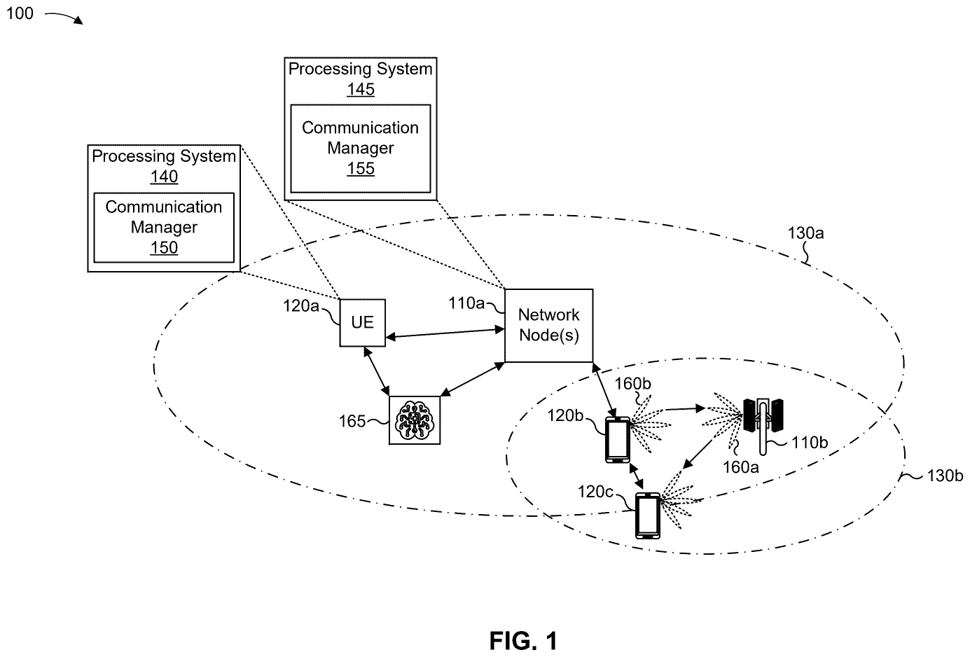

FIG. 1 is a diagram illustrating an example of a wireless communication network 100. The wireless communication network 100 may be or may include elements of a 5G network or a 6G network, among other examples. The wireless communication network 100 may include multiple network nodes 110. For example, in FIG. 1, the wireless communication network 100 includes multiple network nodes 110, including a network node 110a and a network node 110b (each of which also may be referred to herein simply as a “network node 110”). The network nodes 110 may support communications with multiple UEs 120. For example, in FIG. 1, the network nodes 110 support communication with a UE 120a, a UE 120b, and a UE 120c (each of which also may be referred to herein simply as a “UE 120”). In some examples, a UE 120 also may communicate with other UEs 120 and a network node 110 also may communicate with a core network and with other network nodes 110.

The network nodes 110 and the UEs 120 of the wireless communication network 100 communicate using the electromagnetic spectrum, which may be subdivided into various licensed or unlicensed operating bands, frequency ranges, component carriers, or channels that define associated frequencies available for communications. In some examples, each of the network nodes 110 and the UEs 120 may communicate using one or multiple component carriers in one or more operating bands or ranges. Typically, various operating bands are defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR 4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles.

A network node 110 or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system. As shown in FIG. 1, each UE 120 includes a processing system 140 and each network node 110 includes a processing system 145. A processing system (for example, the processing system 140 or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media, such as random-access memory, or read-only memory, or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors. One or more of the memories may individually or collectively store processor-executable code or instructions (such as software) (for example, which may be referred to as “one or more code-storing memories” or “code-storing memory circuitry”). For example, “code-storing memory” or “code-storing memory circuitry” refers to memory (or memory circuitry) that is configured to store processor-executable code or instructions. The processor-executable code or instructions, when executed by one or more of the processors, may configure one or more of the processors (or processing circuitry) to perform various functions or operations described herein. Additionally, or alternatively, in some examples, one or more of the processors may be configured to perform various functions or operations described herein without requiring configuration by software. Software shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 or the processing system 145 may include or implement one or more of the modems. The processing system 140 and the processing system 145 also may include or be coupled with multiple radios (collectively “the radio”), multiple RF chains, or multiple transceivers, each of which may in turn be coupled with one or more of multiple antennas. In some examples, one or more processors of the processing system 140 or the processing system 145 may include or implement one or more of the radios, RF chains, or transceivers. An RF chain may include one or more filters, mixers, oscillators, amplifiers, analog-to-digital converters (ADCs), or other devices that convert between an analog signal (such as for transmission or reception via an air interface) and a digital signal (such as for processing by the processing system 140 or by the processing system 145).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device, such as the network node 110 and the UE 120.

A network node 110 may be, may include, or also may be referred to as an NR network node, a 5G network node, a 6G network node, a Node B, a gNB, an access point (AP), a transmission reception point (TRP), a network entity, a network element, a network equipment, or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may include a single standalone base station or a single TRP that operates with a full radio protocol stack to enable or facilitate communication between a UE 120 and a core network of the wireless communication network 100.

Alternatively, and as also shown, a network node 110 may be a disaggregated network node 110 (sometimes referred to as a disaggregated base station), having a disaggregated architecture, meaning that the network node 110 may operate with a radio protocol stack that is physically distributed or logically distributed among two or more nodes in the same geographic location or in different geographic locations. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The disaggregated network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, or one or more RUs. In some examples, a CU, a DU, or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

In some examples, the wireless communication network 100 may be a heterogeneous network that includes network nodes 110 of various types. Different types of network nodes 110 may generally operate on the same or different operating bands, transmit at different power levels, or serve different coverage areas, each of which may be referred to as or associated with a particular cell 130 (for example, a cell 130a and a cell 130b).

The UEs 120 may be physically dispersed throughout the coverage area of the wireless communication network 100, and each UE 120 may be stationary or mobile. A UE 120 may be, may include, or also may be referred to as an access terminal, a mobile station, a client device, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, or smart jewelry), a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), an artificially intelligent robot or other device implementing artificial intelligence, a UE function of a network node, or any other suitable device or function that may communicate in the wireless communication network 100.

Some UEs 120 may be classified according to different categories in association with different complexities or different capabilities. UEs 120 in a first category may be associated with relatively low complexity or cost such as NB-IoT devices or eMTC UEs. UEs 120 in a second category may include higher complexity or cost devices, such as mission-critical IoT devices, baseline UEs, high-tier UEs, advanced UEs, full-capability UEs, or premium UEs that are capable of URLLC, eMBB, or precise positioning in the wireless communication network 100. A third category of UEs 120 may have mid-tier complexity or capabilities (for example, capabilities between that of the UEs 120 of the first category and the UEs 120 of the second category). A UE 120 of the third category may be referred to as a reduced capability UE (“RedCap UE”), a mid-tier UE, an NR-Light UE, or an NR-Lite UE, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, CCs, subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) or reconfigured (for example, in real-time or near-real-time) according to changing network conditions in the wireless communication network 100 or specific requirements of one or more UEs 120. An active BWP defines the operating bandwidth of the UE 120 within the operating bandwidth of the serving cell.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120 or may transmit, to the UE 120, an indication of an MCS to be applied for an uplink signal.

A network node 110 or a UE 120 (such as by using the processing system 145 or the processing system 140, respectively, or one or more coupled modems) may perform signal processing on the information (such as filtering, amplification, modulation, digital-to-analog conversion, an IFFT operation, multiplexing, interleaving, mapping, or encoding, among other examples) to generate a processed signal in accordance with the selected MCS. In some examples, the network node 110 or the UE 120 (for example, using the processing system 145 or the processing system 140, respectively, or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 or one or more modems) may further perform spatial processing (for example, precoding) on the encoded information to generate one or more processed or precoded signals for downlink or uplink transmission, respectively. In some examples, the network node 110a or the UE 120a may perform codebook-based precoding or non-codebook-based precoding. Codebook-based precoding may involve selecting a precoder (for example, a precoding matrix) using a codebook. For example, the network node 110a may provide precoding information indicating which precoder, defined by the codebook, is to be used by the UE 120a. Non-codebook-based precoding may involve selecting or deriving a precoder based on, or otherwise associated with, one or more downlink or uplink signal measurements. The network node 110a or the UE 120a may transmit the processed downlink or uplink signals, respectively, via one or more antennas.

The network node 110a or the UE 120a may receive uplink signals or downlink signals, respectively, via one or more antennas. The network node 110a or the UE 120a (for example, using the processing system 145 or the processing system 140, respectively, or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, or decoding, among other examples), to map the received signal(s) to a sequence of binary bits (for example, received information) that estimates the information transmitted by the network node 110 or the UE 120 via the downlink or uplink signals. The network node 110a or the UE 120a (for example, using the processing system 145 or the processing system 140, respectively, or a coupled decoder or one or more modems) may decode the received information (such as by using an ECC, a decoding operation, or an FEC operation) to detect errors or correct bit errors in the received information to generate decoded information. The decoded information may estimate the information transmitted via the downlink or uplink signals.

In some examples, a UE 120 and a network node 110 may perform MIMO communication. MIMO communication generally refers to transmitting or receiving multiple signals (such as multiple layers or multiple data streams) simultaneously over the same time and frequency resources. A network node 110 or a UE 120 may communicate using single-user MIMO or multi-user MIMO (MU-MIMO), the latter of which being used by a network node 110 to simultaneously transmit signals to multiple UEs 120. MIMO techniques may involve spatial multiplexing (multi-layer transmission) or beamforming. To implement beamforming, the amplitudes or phases of signals transmitted via antenna elements may be modulated and shifted relative to each other (such as by manipulating a phase shift, a phase offset, or an amplitude) to generate one or more beams. For example, a network node 110 may generate one or more beams 160a, and a UE 120 may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with such a directional transmission or directional reception, a set of directional resources associated with a signal transmission or signal reception (for example, an angle of arrival, a horizontal direction, or a vertical direction), or a set of parameters or resources associated with one or more aspects of a directional signal, among other examples.

In some examples, a network node 110 or a UE 120 may implement massive MIMO, which may be associated with an increased (for example, “massive”) quantity of antennas at the network node 110 or at the UE 120, such as in a network implementing mmWave technology, which enables more precise beamforming or reduced interference. In some examples, the wireless communication network 100 may implement multi-TRP (mTRP) operation (including redundant transmission or reception on multiple TRPs) or non-coherent joint transmission (NC-JT).

The network node 110 and the UE 120 may establish a communication link or beam pair, and otherwise increase reliability, throughput, signal strength, or other signal properties for MIMO communications, by performing beam management operations, such as an initial beam acquisition operation, a beam refinement operation, or a beam recovery operation. For example, an initial beam acquisition operation may involve the network node 110 transmitting signals (for example, SSBs or other signals) via respective beams (for example, of the beams 160 of the network node 110) and the UE 120 receiving and measuring the signal(s) via respective beams of multiple beams (for example, from the beams 160 of the UE 120) to identify a best beam (or beam pair) for communication between the UE 120 and the network node 110. A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified or defined via one or more spatial parameters, such as a transmission configuration indicator (TCI) state or a quasi co-location (QCL) parameter, among other examples.

Some aspects and techniques as described herein may be implemented, at least in part, using an artificial intelligence (AI) program (for example, referred to herein as an “AI/ML model”), such as a program that includes a machine learning (ML) model or an artificial neural network (ANN) model. The AI/ML model may be deployed at one or more devices 165 (for example, one or more network nodes 110, one or more UEs 120, one or more servers, or one or more components of a cloud computing network, among other examples). For example, in a deployment in which AI/ML functionality is performed independently at a device 165, sometimes referred to as “overlay AI/ML,” the AI/ML model (or an instance or portion of the AI/ML model) may be deployed at a UE 120 (for example, by the processing system 140), a network node 110 (for example, by the processing system 145), one or more servers, or one or more components of a cloud computing network, among other examples. Additionally, or alternatively, in a deployment where AI/ML functionality is coordinated between different devices 165, sometimes referred to as “coordinated AI/ML,” or performed at all device and network layers, sometimes referred to as “native AI/ML,” the AI/ML model (or an instance of the AI/ML model) may be deployed at multiple devices 165 (for example, a first portion of the AI/ML model may be deployed at a UE 120 and a second portion of the AI/ML model may be deployed at a network node 110). In other examples of coordinated AI/ML or native AI/ML, a first AI/ML model may be deployed at a UE 120 and a second AI/ML model may be deployed at a network node 110. The AI/ML model(s) may be configured to enhance various aspects of the wireless communication network 100 (for example, to increase privacy, reliability, or efficient use of network bandwidth, or to reduce latency, among other examples). For example, the AI/ML model(s) may be trained to identify patterns or relationships in data corresponding to the wireless communication network 100, a device, or an air interface, among other examples. The AI/ML model(s) may support operational decisions relating to one or more aspects associated with wireless communications devices, networks, or services.

Accordingly, in some examples, the AI/ML model(s) may enable AI-as-a-Service (for example, an end-to-end AI/ML service via a user plane) for use cases, such as a self-organizing network (SON), minimization of drive test (MDT), quality of experience (QoE), positioning, sensing, predictive mobility, or traffic prediction, among other examples. In some examples, AI-as-a-Service use cases may include measurement collection reporting by a UE 120, device selection criteria (for example, according to a geographical area where measurements are to be collected or UE capabilities to be used to collected measurements), or reporting configurations (for example, reporting parameters such as location, time, or sensor information, among other examples). Additionally, or alternatively, the AI/ML model(s) may enable AI/ML procedures (for example, RAN-triggered service establishment, configuration, inferencing using UE-side or network-side models, performance monitoring or management, or capability signaling, among other examples). Additionally, or alternatively, the AI/ML model(s) may enable RAN-based AI/ML services via one or more application program interfaces (APIs) or management interfaces for use cases, such as beam management, radio resource monitoring (RRM) relaxation, mobility prediction, load prediction, network energy savings, or coverage and capacity improvements, among other examples).

In some aspects, a UE (e.g., the UE 120) may include a communication manager 150. As described in more detail elsewhere herein, the communication manager 150 may receive a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and perform a collision handling between a first transmission associated with the first CC and a second transmission associated with the second CC based at least in part on a set of collision handling rules. Additionally, or alternatively, the communication manager 150 may perform one or more other operations described herein.

In some aspects, a network node (e.g., the network node 110) may include a communication manager 155. As described in more detail elsewhere herein, the communication manager 155 may transmit a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; and detect a collision handling between a first transmission associated with the first CC and a second transmission associated with the second CC based at least in part on a set of collision handling rules. Additionally, or alternatively, the communication manager 155 may perform one or more other operations described herein.

As indicated above, FIG. 1 is provided as an example. Other examples may differ from what is described with regard to FIG. 1.

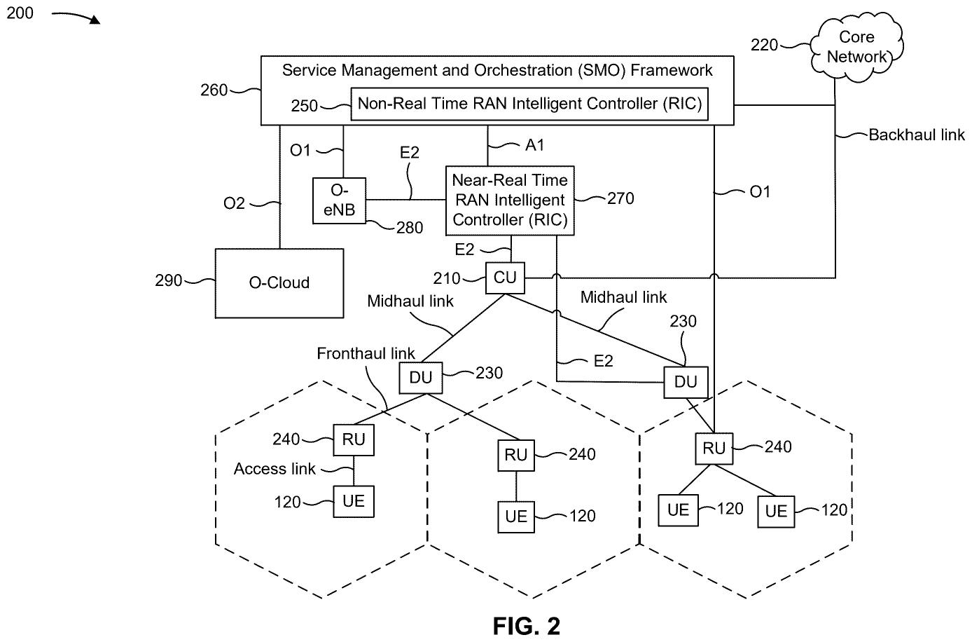

FIG. 2 is a diagram illustrating an example disaggregated network node architecture 200. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for transmitting or receiving signals, such as data, control information, or reference signals via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, or a Near-RT RIC 270. In some aspects, the SMO Framework 260 may communicate with a hardware aspect of a 4G RAN, a 5G NR RAN, or a 6G RAN, such as an open eNB (O-eNB) 280, via an O1 interface. Additionally, or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, or policy-based guidance of applications or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

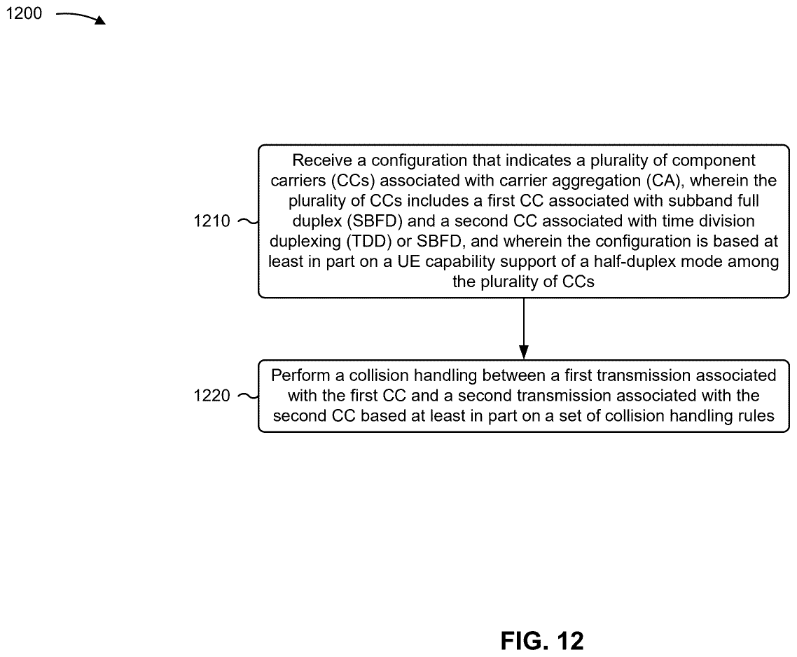

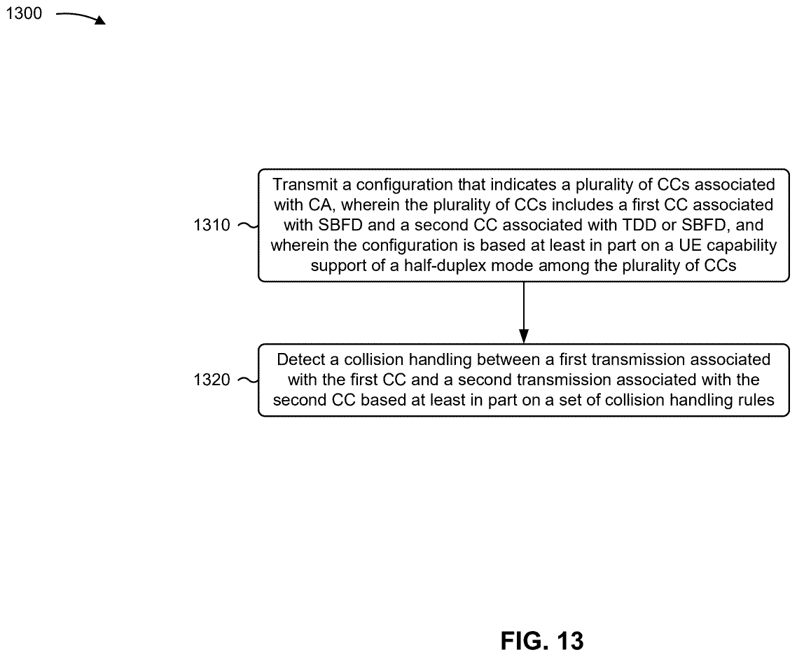

The network node 110, the processing system 145 of the network node 110, the UE 120, the processing system 140 of the UE 120, the CU 210, the DU 230, the RU 240, or any other component(s) of FIG. 1 or FIG. 2 may implement one or more techniques or perform one or more operations associated with collision handling between transmissions associated with CA and SBFD, as described in more detail elsewhere herein. For example, the processing system 145 of the network node 110, the processing system 140 of the UE 120, the CU 210, the DU 230, or the RU 240 may perform or direct operations of, for example, process 1200 of FIG. 12, process 1300 of FIG. 13, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1200 of FIG. 12, process 1300 of FIG. 13, or other processes as described herein. In some examples, executing instructions may include running the instructions, converting the instructions, compiling the instructions, or interpreting the instructions, among other examples.

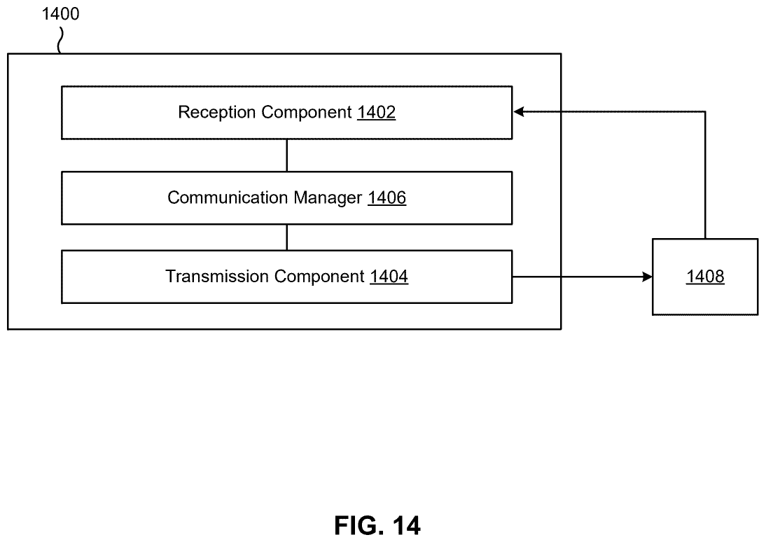

In some aspects, a UE (e.g., the UE 120) includes means for receiving a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; or means for performing a collision handling between a first transmission associated with the first CC and a second transmission associated with the second CC based at least in part on a set of collision handling rules. The means for the UE to perform operations described herein may include, for example, one or more of communication manager 150, processing system 140, a radio, one or more RF chains, one or more transceivers, one or more antennas, one or more modems, a reception component (for example, reception component 1402 depicted and described in connection with FIG. 14), or a transmission component (for example, transmission component 1404 depicted and described in connection with FIG. 14), among other examples.

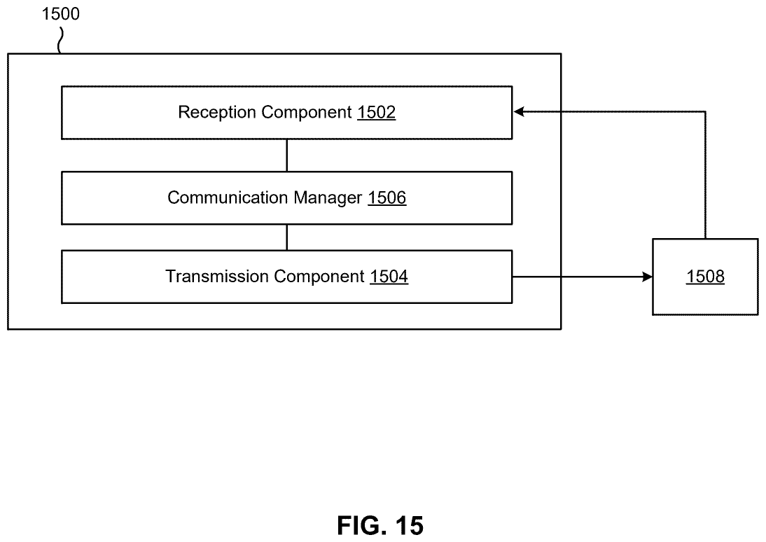

In some aspects, a network node (e.g., the network node 110) includes means for transmitting a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs; or means for detecting a collision handling between a first transmission associated with the first CC and a second transmission associated with the second CC based at least in part on a set of collision handling rules. The means for the network node to perform operations described herein may include, for example, one or more of communication manager 155, processing system 145, a radio, one or more RF chains, one or more transceivers, one or more antennas, one or more modems, a reception component (for example, reception component 1502 depicted and described in connection with FIG. 15), or a transmission component (for example, transmission component 1504 depicted and described in connection with FIG. 15), among other examples.

As indicated above, FIG. 2 is provided as an example. Other examples may differ from what is described with regard to FIG. 2.

An FD operation may involve an in-band full duplex (IBFD) operation, in which a transmission and a reception may occur on the same time and frequency resource. A downlink direction and an uplink direction may share the same IBFD time/frequency resource based at least in part on a full or partial overlap. Alternatively, the FD operation may involve an SBFD operation, in which a transmission and a reception may occur at the same time but on different frequency resources. A downlink resource may be separated from an uplink resource in a frequency domain. In the SBFD operation, no downlink and uplink overlap in frequency may occur.

The SBFD operation may increase an uplink duty cycle, which may result in a latency reduction (e.g., a downlink signal may be received in uplink-only slots, which may enable latency savings) and uplink coverage improvement. The SBFD operation may improve a system capacity, resource utilization, and/or spectrum efficiency. The SBFD operation may enable a flexible (FL) and dynamic uplink (UL)/downlink (DL) resource adaption according to uplink/downlink traffic in a robust manner.

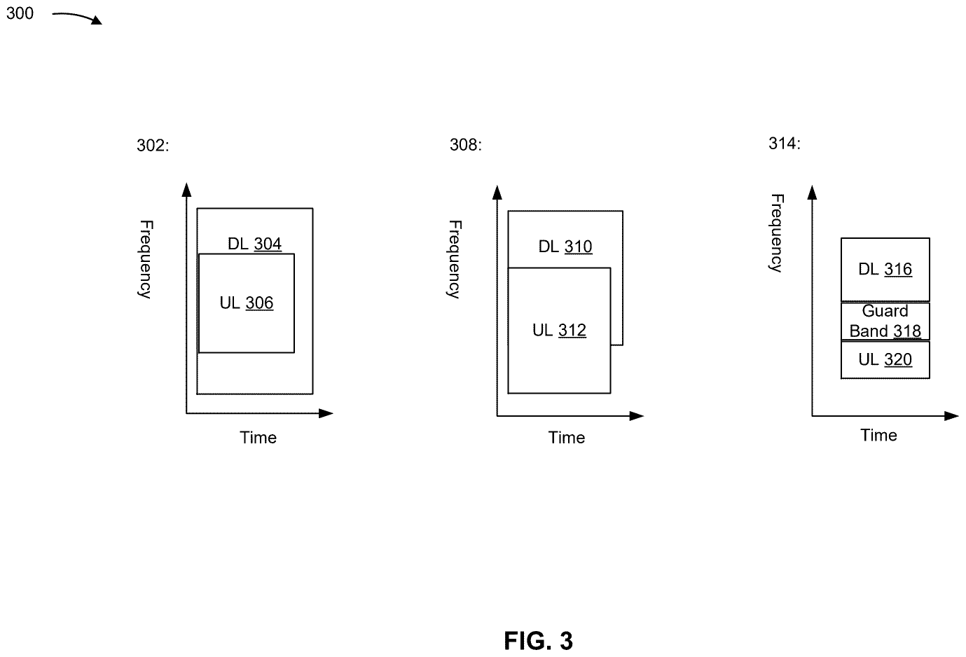

FIG. 3 is a diagram illustrating examples 300 of FD communications.

As shown by reference number 302, a downlink resource 304 and an uplink resource 306 may share the same IBFD time/frequency resource based at least in part on a full overlap. As shown by reference number 308, a downlink resource 310 and an uplink resource 312 may share the same IBFD time/frequency resource based at least in part on a partial overlap. As shown by reference number 314, a downlink resource 316 and an uplink resource 320 may be associated with a same time but different frequencies. The downlink resource 316 and the uplink resource 320 may be separated by a guard band 318.

As indicated above, FIG. 3 is provided as an example. Other examples may differ from what is described with regard to FIG. 3.

An SBFD operation in a TDD band may provide an uplink coverage/capacity gain. A semi-static indication of a time/frequency domain location of SBFD sub-bands to UEs in connected mode may be defined for the SBFD operation. Random access procedures in SBFD symbols may be defined for the SBFD operation. A UE transmission, reception, and measurement behavior may be defined for the SBFD operation. Procedures in SBFD symbols and/or non-SBFD symbols for SBFD-aware UEs may be defined for the SBFD operation. Enhancements for cross-link interference (CLI) handling may be defined for the SBFD operation.

The SBFD operation may imply a simultaneous Tx/Rx of downlink/uplink on a sub-band basis at a network node. A UE may still operate in an HD mode (e.g., either receive or transmit at a given time). The SBFD operation may provide latency reduction by allowing a transmission of uplink channels/signals in an uplink subband in legacy downlink slots and a reception of downlink channels/signals in a downlink subband in legacy uplink slots. The SBFD operation may provide an uplink coverage enhancement. The SBFD operation may provide a flexible/dynamic uplink/downlink resource adaptation according to uplink/downlink traffic.

A semi-static cell-specific SBFD time configuration may be defined. SBFD symbols may be indicated via a system information block type 1 (SIB1). For example, SBFD symbols may be indicated via a serving cell. SBFD symbols may be indicated via a UE-dedicated cell-common configuration. For example, SBFD symbols may be indicated via a secondary cell (SCell).

An SBFD-aware UE may transmit and receive within SBFD symbols, in which case various time domain collision handling scenarios may be defined. For SBFD-aware UEs, collisions between a downlink reception in one or more downlink subbands and an uplink transmission in an uplink subband in an SBFD symbol may be addressed or alleviated with proper scheduling. A first case may involve a dynamically scheduled downlink reception versus a semi-statically configured uplink transmission (e.g., a dynamic PDSCH transmission or CSI-RS collides with a configured SRS transmission, PUCCH transmission, or configured grant (CG) PUSCH transmission). In the first case, an uplink transmission may be cancelled within a cancellation timeline. A second case may involve a semi-statically configured downlink reception versus a dynamically scheduled uplink transmission (e.g., a PDCCH transmission or semi-persistent scheduling (SPS) PDSCH transmission collides with a dynamic PUSCH transmission or PUCCH transmission). In the second case, a downlink reception may be cancelled. A third case may involve a semi-statically configured downlink reception versus a semi-statically configured uplink transmission. In the third case, new rules may be defined. A fourth case may involve a dynamically scheduled downlink reception versus a dynamic scheduled uplink transmission. The fourth case may not be expected (error case). A fifth case may involve an SSB transmission versus a dynamically scheduled or configured uplink transmission (e.g., a PUSCH transmission, PUCCH transmission, PRACH transmission, or SRS transmission). In the fifth case, the SSB transmission may be prioritized over the dynamically scheduled or configured uplink transmission. A sixth case may involve a dynamic or semi-static downlink transmission versus a valid random access channel (RACH) occasion (RO). In addition to collision handling between an uplink transmission and a downlink reception in the same SBFD symbol, collision handling between an uplink transmission and a downlink reception in a different symbol due to a lack of sufficient transition time between Tx/Rx at the UE may be defined.

The various time domain collision handling scenarios may be defined. For the first case, a handling/resolution rule may involve reusing existing collision handling rules and timelines in NR for operation on flexible symbols on a single carrier in an unpaired spectrum. For example, an uplink transmission may be cancelled when a cancellation timeline is satisfied. For the second case, a handling/resolution rule may involve reusing existing collision handling principles in NR for operation on flexible symbols on a single carrier in an unpaired spectrum. For example, the UE may not receive a downlink channel/signal. The third case may be an error case. The fourth case may be an error case. For the fifth case, a handling/resolution rule may involve prioritizing the SSB transmission over a configured uplink transmission or a dynamically scheduled uplink transmission. The SSB symbols configured with SBFD subbands may be SBFD symbols. A downlink reception within downlink usable physical resource blocks (PRBs) may be allowed for SBFD-aware UEs. For the sixth case, the UE may not expect a collision between a PRACH transmission triggered by a PDCCH order and a dynamically scheduled downlink reception (error case). For a collision between a PRACH transmission triggered by a PDCCH order and a semi-statically configured downlink reception, the UE may not receive a downlink channel/signal. For a collision between a PRACH transmission triggered by a higher layer and a downlink channel/signal, the UE may receive the downlink channel/signal or transmit the PRACH transmission based at least in part on a UE implementation.

For the sixth case, a handling/resolution rule may involve reusing existing collision handling rules for HD frequency division duplexing (FDD) RedCap UEs. For the sixth case, a PRACH transmission triggered by DCI (PDCCH) order that collides with a dynamic downlink transmission may result in an error case. A PRACH transmission triggered by DCI (PDCCH) order that collides with a semi-static downlink transmission may result in the semi-static downlink transmission being cancelled and the PRACH transmission being transmitted. A PRACH transmission triggered by a higher layer that collides with a dynamic/semi-static downlink transmission may be handled in accordance with a UE implementation. When a PDCCH monitoring occasion (MO) overlaps with a RACH transmission, the UE may receive DCI or transmit a PRACH transmission based at least in part on the UE implementation.

A CA and an SBFD operation may be defined (e.g., SBFD with multi-carrier). The SBFD operation may be supported on one TDD carrier in a multi-carrier scenario. When a TDD carrier for the SBFD operation is an SCell, UE dedicated signaling may be supported for a cell-specific configuration of time and frequency location of SBFD subbands for the SCell. The SBFD operation may be supported for an HD CA case.

Priority rules for collision handling may be defined for TDD CA. The priority rules may be for HD CA and may resolve collisions of conflicting uplink/downlink transmissions across TDD CCs. In other words, HD CA collision handling may be defined. Directional collision handling rules may be defined between a reference cell and other cells for an HD operation in TDD CA with the same SCS. The TDD CA may have different TDD uplink/downlink configurations across CCs. The reference cell may be an active cell with a smallest cell index among configured multiple serving cells. An HD TDD CA same SCS (e.g., half-DuplexTDD-CA-SameSCS-r16) parameter may indicate whether a UE supports directional collision handling between the reference cell and other cells for the HD operation in TDD CA with the same SCS.

In scenario 1, when a reference cell is associated with a semi slot format indicator (SFI) downlink (D) and another cell is associated with a semi SFI uplink (U), a UE behavior may involve dropping the semi SFI U for an inter-band (error case in an intra-band). In scenario 2, when a reference cell is associated with a semi SFI D and another cell is associated with an RRC U, a UE behavior may involve dropping the RRC U. In scenario 3, when a reference cell is associated with a semi SFI D and another cell is associated with a dynamic U, a UE behavior may involve dropping the dynamic U for an inter-band (error case in an intra-band). In scenario 4, when a reference cell is associated with a semi SFI U and another cell is associated with a semi SFI D, a UE behavior may involve dropping the semi SFI D for an inter-band (error case in an intra-band). In scenario 5, when a reference cell is associated with a semi SFI U and another cell is associated with an RRC D, a UE behavior may involve dropping the RRC D. In scenario 6, when a reference cell is associated with a semi SFI U and another cell is associated with a dynamic D, a UE behavior may be associated with an error. In scenario 7, when a reference cell is associated with an RRC D and another cell is associated with an RRC U, a UE behavior may involve dropping the RRC U. In scenario 8, when a reference cell is associated with an RRC U and another cell is associated with an RRC D, a UE behavior may involve dropping the RRC D. In scenario 9, when a reference cell is associated with a dynamic D and another cell is associated with a dynamic U, a UE behavior may be associated with an error. In scenario 10, when a reference cell is associated with a dynamic U and another cell is associated with a dynamic D, a UE behavior may be associated with an error. In scenario 11, when a reference cell is associated with an RRC U and another cell is associated with a semi SFI D, a UE behavior may involve dropping the semi SFI D. In scenario 12, when a reference cell is associated with an RRC D and another cell is associated with a semi SFI U, a UE behavior may involve dropping the semi SFI U. In scenario 13, when a reference cell is associated with an RRC U and another cell is associated with a dynamic D, a UE behavior may be associated with an error. In scenario 14, when a reference cell is associated with an RRC D and another cell is associated with a dynamic U, a UE behavior may involve dropping the RRC D for an inter-band (error case in an intra-band).

A collision handling for HD CA across CCs may be defined. “Semi SFI D and U” may refer to D and U symbols configured by a common TDD uplink/downlink configuration (TDD-UL-DL-ConfigurationCommon) or a dedicated TDD uplink/downlink configuration (TDD-UL-DL-ConfigDedicated). “Semi SFI F” may refer to flexible symbols configured by the common TDD uplink/downlink configuration or the dedicated TDD uplink/downlink configuration when provided to a UE, or when the common TDD uplink/downlink configuration and the dedicated TDD uplink/downlink configuration are not provided to the UE. “RRC D” may refer to symbols corresponding to a higher-layer configured PDCCH, or a PDSCH, or a CSI-RS on a semi SFI F of the same cell. “RRC U” may refer to symbols corresponding to a higher-layer configured SRS, or PUCCH, or PUSCH, or PRACH on a semi SFI F of the same cell. “Dynamic D and U” may refer to symbols scheduled as D and U by DCI formats other than DCI format 2_0 on a semi SFI F of the same cell.

When a UE is configured with multiple serving cells and is provided with a directional collision handling (e.g., directionalCollisionHandling-r16=‘enabled’) for a set of serving cells among a configured multiple serving cells, and when the UE indicates support of an HD TDD CA capability (e.g., half-DuplexTDD-CA-SameSCS-r16 capability), and when the UE is not configured to monitor a PDCCH for detection of DCI format 2_0 on any of the multiple serving cells, the UE may determine a reference cell for a symbol as an active cell with a smallest cell index. The smallest cell index may be among the configured multiple serving cells when the UE is not capable of simultaneous transmission and reception, as indicated by a simultaneous Rx-Tx inter-band CA (simultaneousRxTxInterBandCA) parameter, among the multiple serving cells. The smallest cell index may be among the cells of each band respectively when the UE is capable of simultaneous transmission and reception, as indicated by simultaneousRxTxInterBandCA, for the configured multiple serving cells. The symbol may be configured as downlink, or uplink, as indicated by tdd-UL-DL-ConfigurationCommon or tdd-UL-DL-ConfigurationDedicated. The symbol may be configured as uplink, when the symbol is flexible and the UE is configured by higher layers to transmit an SRS transmission, PUCCH transmission, PUSCH transmission, or PRACH transmission on the symbol. The symbol may be configured as downlink, when the symbol is flexible and the UE is configured by higher layers to receive a PDCCH transmission, PDSCH transmission, or CSI-RS transmission on the symbol.

A reference cell may depend on a smallest cell index. A UE symbol direction (e.g., downlink or uplink) may be associated with a UE traffic direction. When a reference cell is an SBFD cell and a symbol is an SBFD symbol (downlink/flexible), then the symbol may be considered as uplink or downlink. For example, the symbol may be uplink for a dynamic grant (DG) transmission in an uplink subband of an SBFD symbol.

When a UE is configured with multiple serving cells and is provided with directional collision handling (e.g., directionalCollisionHandling-r16=‘enabled’) for a set of serving cells among the multiple serving cells, and when the UE indicates support of a half-DuplexTDD-CA-SameSCS-r16 capability, and when the UE is not configured to monitor a PDCCH for detection of DCI format 2_0 on any of the multiple serving cells, for a set of symbols of a slot that are indicated to the UE for reception of SS/PBCH blocks in a first cell of the multiple serving cells by an SSB position in burst (ssb-PositionsInBurst) in a system information block type 1 (SIB1) or by ssb-PositionsInBurst in a common serving cell configuration (ServingCellConfigCommon) or, when the UE is not provided with a downlink or joint TCI state list (dl-OrJointTCI-StateList), by ssb-PositionsInBurst in an SSB multi-tone cell (MTC) additional physical cell identifier (ID) (PCI) (SSB-MTCAdditionalPCI) associated with a PCI with active TCI states for a PDCCH or a PDSCH, or for a set of symbols of a slot corresponding to SS/PBCH blocks configured for L1 beam measurement/reporting, the UE may not transmit a PUSCH transmission, PUCCH transmission, or PRACH transmission in the slot. The UE may not transmit the PUSCH transmission, PUCCH transmission, or PRACH transmission when a transmission would overlap with any symbol from the set of symbols. The UE may not transmit an SRS transmission in the set of symbols of the slot in any of the multiple serving cells when the UE is not capable of simultaneous transmission and reception, as indicated by simultaneousRxTxInterBandCA, among the multiple serving cells. The UE may not transmit an SRS transmission in the set of symbols of the slot in any one of the cells corresponding to the same band as the first cell, irrespective of any capability indicated by simultaneousRxTxInterBandCA.

No uplink transmission (e.g., SRS, PUCCH, PUSCH, or PRACH) may be permitted in a slot when the uplink transmission overlaps with an SSB of any of the serving cells, in accordance with an SSB restriction. When a set of symbols of a slot is indicated for SSB reception in a cell, then the UE may not transmit a PUCCH transmission, PUSCH transmission, or PRACH transmission in the slot when the transmission overlaps with any symbol. The UE may not transmit an SRS transmission in the set of symbols. An SSB may be in a downlink subband of an SBFD symbol in an SBFD cell.

When another cell among cells configured with directional collision handling (e.g., directionalCollisionHandling-r16) operates in the same frequency band as the reference cell, the UE may not expect a symbol to be indicated as downlink or uplink on the reference cell and as uplink or downlink on another cell, respectively, by tdd-UL-DL-ConfigurationCommon or by tdd-UL-DL-ConfigurationDedicated (e.g., uplink/downlink symbols in reference cell versus downlink/uplink symbols on other cells). The UE may not expect tdd-UL-DL-ConfigurationCommon or tdd-UL-DL-ConfigurationDedicated to indicate a symbol as downlink on the reference cell and to detect a DCI format scheduling a transmission on the symbol on another cell (e.g., downlink symbols in reference cell versus uplink DCI in flexible symbols on other cells). The UE may not expect to be configured by higher layers to receive a PDCCH transmission, PDSCH transmission, or CSI-RS transmission on a flexible symbol on the reference cell and to detect a DCI format scheduling a transmission on the symbol on another cell (e.g., RRC based downlink signal/channel in flexible symbols in reference cell versus uplink DCI in flexible symbols on other cells).

In one example, error cases may be defined for intra-band CA. In a first scenario, a reference cell may be TDD and another cell may be TDD or SBFD. For example, a downlink symbol versus an SBFD symbol may be allowed, in which case a UE may receive in a downlink subband. As another example, an uplink symbol versus an SBFD symbol may not be allowed. As yet another example, a downlink symbol versus a DG uplink in an SBFD symbol may be allowed. In a second scenario, a reference signal may be SBFD and another cell may be TDD or SBFD.

When the reference cell and another cell among cells configured with directional collision handling (directionalCollisionHandling-r16) operate in different frequency bands, the UE may assume a symbol as flexible, the UE may not be required to receive a higher layer configured PDCCH transmission, PDSCH transmission, or CSI-RS transmission, and the UE may not be expected to transmit a higher layer configured SRS transmission, PUCCH transmission, PUSCH transmission, or PRACH transmission, when tdd-UL-DL-ConfigurationCommon or tdd-UL-DL-ConfigurationDedicated indicates the symbol as downlink or uplink on another cell and as uplink or downlink for the reference cell. In this example, uplink/downlink symbols in the reference cell versus downlink/uplink on other cells may be resolved by treating the uplink/downlink symbols in the reference cells as flexible symbols, dropping RRC downlink symbols, and/or considering RRC uplink symbols to be an error. A resolution may be based at least in part on a collision rule for inter-band CA.

When the reference cell and another cell among cells configured with directional collision handling (directionalCollisionHandling-r16) operate in different frequency bands, the UE may transmit a signal/channel scheduled by a DCI format on a symbol of another cell when the symbol is indicated as downlink by tdd-UL-DL-ConfigurationCommon or tdd-UL-DL-ConfigurationDedicated for the reference cell. In this example, downlink symbols in the reference symbol versus DG uplink symbols on other cells may be resolved by transmitting the downlink symbols. A resolution may be based at least in part on a collision rule for inter-band CA.

When the reference cell and another cell among cells configured with directional collision handling (directionalCollisionHandling-r16) operate in different frequency bands, the UE may not be required to receive a higher layer configured PDCCH transmission, PDSCH transmission, or CSI-RS transmission on flexible symbols on the reference cell in a set of symbols, when the UE detects a DCI format scheduling a transmission on one or more symbols in the set of symbols on another cell. In this example, RRC downlink symbols in the reference cell versus DG uplink symbols on other cells may be resolved by dropping the RRC downlink symbols in the reference cell. A resolution may be based at least in part on a collision rule for inter-band CA.

Error cases for intra-band and inter-band CA may be defined. Regardless of whether a reference cell and another cell operate in the same or different frequency bands, the UE may not expect tdd-UL-DL-ConfigurationCommon or tdd-UL-DL-ConfigurationDedicated for the reference cell to indicate a symbol as uplink and to detect a DCI format scheduling a reception on the symbol on another cell (e.g., uplink symbols in the reference signal versus downlink DCI in flexible symbols of other cells). The UE may not expect to be configured by higher layers to transmit an SRS transmission, PUCCH transmission, PUSCH transmission, or PRACH transmission on a flexible symbol on the reference cell and to detect a DCI format scheduling a reception on the symbol on another cell (e.g., RRC downlink signal/channel in flexible symbols of reference cell versus uplink DCI in flexible symbols of other cells). The UE may not expect to detect a first DCI format scheduling a transmission or reception on a symbol on a first cell and a second DCI format scheduling a reception or transmission on the symbol on a second cell (e.g., downlink/uplink DCI in flexible symbols of reference cell versus uplink/downlink DCI in flexible symbols of other cells).

Collision rules for intra-band CA and inter-band CA may be defined. Regardless of whether a reference cell and another cell operate in the same or different frequency bands, the UE may not transmit a PUCCH transmission, PUSCH transmission, or PRACH transmission that is configured by higher layers on a set of symbols on another cell if at least one symbol from the set of symbols is indicated as downlink by tdd-UL-DL-ConfigurationCommon or tdd-UL-DL-ConfigurationDedicated or is a symbol corresponding to a PDCCH transmission, PDSCH transmission, or CSI-RS transmission that is configured by higher layers on the reference cell (e.g., the UE may drop an RRC uplink transmission in other cells versus downlink symbols of the reference cell). The UE may not transmit an SRS transmission that is configured by higher layers on a set of symbols on another cell when the set of symbols is indicated as downlink by tdd-UL-DL-ConfigurationCommon or tdd-UL-DL-ConfigurationDedicated or corresponds to a PDCCH transmission, PDSCH transmission, or CSI-RS transmission that is configured by higher layers on the reference cell (e.g., the UE may drop an uplink transmission in other cells versus downlink symbols of the reference cell). The UE may not receive a PDCCH transmission, PDSCH transmission, or CSI-RS transmission that is configured by higher layers on a set of symbols on another cell when at least one symbol from the set of symbols is indicated as uplink by tdd-UL-DL-ConfigurationCommon or tdd-UL-DL-ConfigurationDedicated or is a symbol corresponding to an SRS transmission, PUCCH transmission, PUSCH transmission, or PRACH transmission that is configured by higher layers on the reference cell (e.g., the UE may drop an RRC downlink transmission in other cells versus uplink symbols of the reference cell, or the UE may drop an RRC downlink transmission in other cells versus RRC uplink symbols in the reference cell). The UE may assume a symbol indicated as downlink or uplink by tdd-UL-DL-ConfigurationCommon or tdd-UL-DL-ConfigurationDedicated on another cell to be flexible, when the UE is respectively configured by higher layers to transmit an SRS transmission, PUCCH transmission, PUSCH transmission, or PRACH transmission or to receive a PDCCH transmission, PDSCH transmission, or CSI-RS transmission on the reference cell (e.g., the UE may treat downlink/uplink symbols in other cells as flexible symbols versus RRC uplink/downlink symbols in the reference cell, where the UE may drop the downlink/uplink symbols in other cells).

An SBFD operation may be within a carrier and rules may be specified for handling a collision between conflict uplink/downlink transmissions in SBFD symbols. An SBFD-aware UE may be configured with a CA operation (e.g., an intra-band or inter-band CA operation) where one or more CCs may be associated with an SBFD mode. However, an HD CA UE may not be configured to resolve conflicts (or collisions) across different CCs in SBFD symbols. Such conflicts may result in certain uplink/downlink transmissions across different CCs in SBFD symbols being dropped. For example, certain uplink/downlink transmissions that should be prioritized may be dropped, while certain uplink/downlink transmissions that should not be prioritized may be transmitted, which may degrade an overall system performance. Additionally, a network may be in-sync with a UE behavior of such collision scenarios. The SBFD operation in one or more servings cells may introduce additional collision rules that were not present when all serving cells are operating in a TDD mode.

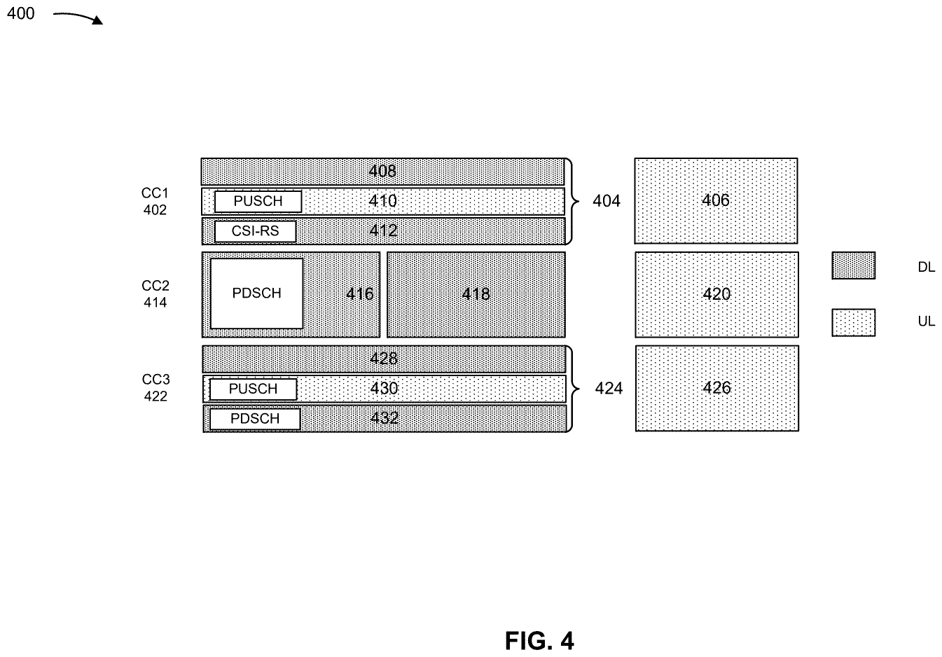

FIG. 4 is a diagram illustrating an example 400 of conflicts across different CCs in SBFD symbols.

As shown in FIG. 4, a first CC (CC1) 402 may be associated with an SBFD slot 404 and an uplink slot 406. The SBFD slot 404 may be associated with a first downlink resource 408, an uplink resource 410, and a second downlink resource 412. A PUCCH transmission associated with the uplink resource 410 may conflict with a CSI-RS transmission associated with the second downlink resource 412. A second CC (CC2) 414 may be associated with a first downlink slot 416, a second downlink slot 418, and an uplink slot 420. The first downlink slot 416 may be associated with a PDSCH transmission. A third CC (CC3) 422 may be associated with an SBFD slot 424 and an uplink slot 426. The SBFD slot 424 may be associated with a first downlink resource 428, an uplink resource 430, and a second downlink resource 432. A PUCCH transmission associated with the uplink resource 430 may conflict with a PDSCH transmission associated with the second downlink resource 432. In these examples, conflicts across different CCs in SBFD symbols may occur, which may degrade an overall system performance.

As indicated above, FIG. 4 is provided as an example. Other examples may differ from what is described with regard to FIG. 4.

In various aspects of techniques and apparatuses described herein, a UE (e.g., an HD CA UE) may receive, from a network node, a configuration that indicates a plurality of CCs associated with CA. The CA may be an intra-band CA or an inter-band CA. The plurality of CCs may include a first CC associated with SBFD and a second CC associated with TDD or SBFD. The UE may receive the configuration based at least in part on a UE capability support of an HD mode among the plurality of CCs, where the plurality of CCs may include SBFD CCs and TDD CCs (e.g., CCs associated with SBFD and CCs associated with TDD). The UE may perform a collision handling between a first transmission associated with the first CC and a second transmission associated with the second CC based at least in part on a set of collision handling rules. The UE, as part of the collision handling, may transmit the first transmission and drop the second transmission based at least in part on the set of collision handling rules. The UE, as part of the collision handling, may transmit the second transmission and drop the first transmission based at least in part on the set of collision handling rules. In one example, the first transmission may be an uplink transmission, the second transmission may be a downlink transmission, and the second CC may be associated with TDD or SBFD. In another example, the first transmission may be a downlink transmission, the second transmission may be an uplink transmission, and the second CC may be associated with SBFD.

In some aspects, collision handling rules may be defined for HD CA with SBFD cells. An HD CA UE may resolve conflicts across different CCs in SBFD symbols in accordance with the collision handling rules. The collision handling rules for HD CA and SBFD may be based at least in part on collision handling rules for resolving collisions of conflicting uplink/downlink transmissions across TDD CCs. The collision handling rules for HD CA and SBFD may involve determining whether a symbol of an SBFD reference cell is a downlink symbol or an uplink symbol. The collision handling rules for resolving collisions of conflicting uplink/downlink transmissions across TDD CCs may be extended to scenarios when one or more CCs are associated with SBFD. By implementing the collision handling rules for HD CA and SBFD, prioritized transmissions may be transmitted and non-prioritized transmissions may be dropped, which may improve an overall system performance.

In some aspects, by configuring the UE with the plurality of CCs associated with CC and by configuring the UE with the set of collision handling rules, the UE may be able to perform the collision handling between the first transmission associated with the first CC and the second transmission associated with the second CC based at least in part on the set of collision handling rules. The UE may be able to perform collision handling across multiple CCs, where at least one of the multiple CCs is associated with SBFD. The collision handling may be for SBFD with multiple CCs, as opposed to collision handling that is for SBFD and a single carrier. The collision handling may resolve uplink/downlink collisions across the multiple CCs. As a result, the UE may be able to perform collision handling across the plurality of CCs for HD CA with SBFD, thereby improving an overall system performance.

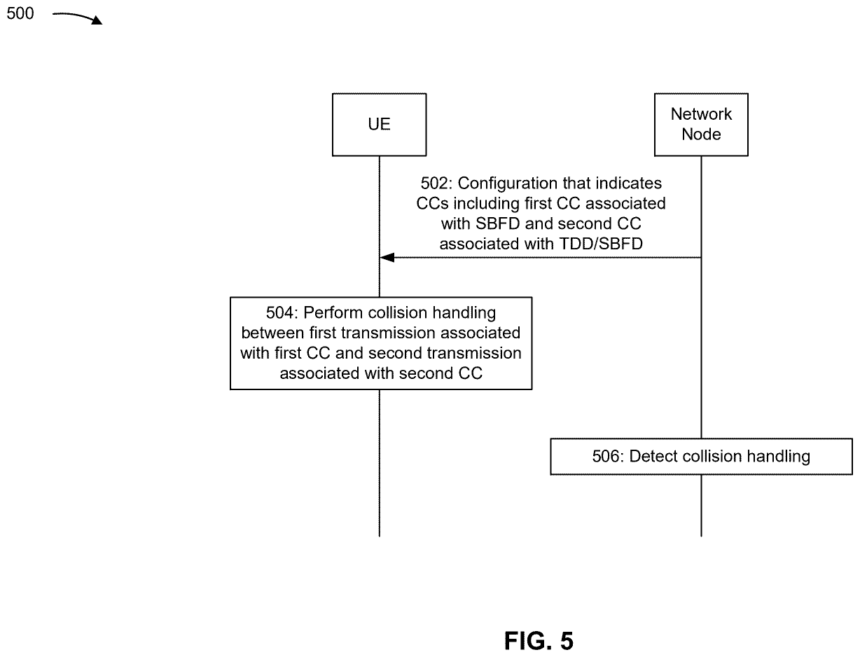

FIG. 5 is a diagram illustrating an example 500 associated with collision handling between transmissions associated with CA and SBFD. As shown in FIG. 5, example 500 includes communication between a UE (e.g., UE 120) and a network node (e.g., network node 110). In some aspects, the UE and the network node may be included in a wireless network, such as wireless network 100. The UE may be an HD CA UE.

As shown by reference number 502, the UE may receive, from the network node, a configuration that indicates a plurality of CCs associated with CA. The CA may be an intra-band CA or an inter-band CA. The plurality of CCs may include a first CC associated with SBFD and a second CC associated with TDD or SBFD. The UE may receive the configuration via RRC signaling. In one example, the first CC may be associated with SBFD and the second CC may be associated with SBFD. In another example, the first CC may be associated with SBFD and the second CC may be associated with TDD, or vice versa. In other words, the UE may be configured with multiple CCs as part of the CA, and at least some of the multiple CCs may be associated with SBFD. The UE may receive the configuration based at least in part on a UE capability support of an HD mode among the plurality of CCs. The plurality of CCs may include SBFD CCs (e.g., CCs associated with SBFD) and TDD CCs (e.g., CCs associated with TDD).

As shown by reference number 504, the UE may perform a collision handling between a first transmission associated with the first CC and a second transmission associated with the second CC based at least in part on a set of collision handling rules. In some aspects, the collision handling may include transmitting the first transmission and dropping the second transmission based at least in part on the set of collision handling rules. Alternatively, the collision handling may include transmitting the second transmission and dropping the first transmission based at least in part on the set of collision handling rules. In some aspects, the first transmission may be an uplink transmission, the second transmission may be a downlink transmission, and the second CC may be associated with TDD or SBFD. Alternatively, the first transmission may be a downlink transmission, the second transmission may be an uplink transmission, and the second CC may be associated with SBFD.

In some aspects, the plurality of CCs may be associated with a reference cell and a non-reference cell. The reference cell may be an active cell with a lowest cell index among a plurality of cells associated with the plurality of CCs. A symbol associated with the reference cell may be based at least in part on a configured uplink transmission or a configured downlink reception. In some aspects, the symbol may be a downlink symbol based at least in part on the symbol being an SBFD symbol and the UE being configured to receive a downlink transmission on the symbol or based at least in part on a collision rule that prioritizes downlink reception in the symbol when there is a conflict between an uplink transmission and the downlink reception in SBFD symbols. In some aspects, the symbol may be an uplink symbol based at least in part on the symbol being an SBFD symbol and the UE being configured to transmit an uplink transmission on the symbol or based at least in part on a collision rule that prioritizes uplink transmission in the symbol when there is a conflict between the uplink transmission and a downlink reception in SBFD symbols. In some aspects, the plurality of CCs may be associated with a reference cell and a non-reference cell. The reference cell may be an active cell with a lowest cell index among a plurality of cells associated with the plurality of CCs. A symbol associated with the reference cell may be a flexible symbol based at least in part on the symbol being an SBFD symbol.

In some aspects, for an SBFD-aware UE configured with multiple serving cells, with one or more SBFD cells, and when the UE does not support simultaneous transmission and reception in TDD-TDD intra-band CA or TDD-TDD inter-band dual connectivity (DC), the UE may determine a reference cell in a symbol associated with a serving cell as an active cell with a smallest cell index. The symbol may be configured or determined based at least in part on a configured uplink transmission or downlink reception. The symbol may be a downlink symbol when the symbol is an SBFD symbol and the UE is configured to receive a PDCCH transmission, a PDSCH transmission, an SSB transmission, a positioning reference signal (PRS) transmission, or a CSI-RS transmission on the symbol. The symbol may be an uplink symbol when the symbol is an SBFD symbol and the UE is configured to transmit an SRS transmission, a PUCCH transmission, a PUSCH transmission, or a PRACH transmission on the symbol. The symbol may be configured or determined based at least in part on a flexible symbol when the symbol is an SBFD symbol. The symbol may be configured or determined based at least in part on a configuration by a higher layer or a scheduling by DCI. An SBFD symbol may be configured in a downlink symbol or a flexible symbol by a common TDD uplink/downlink configuration. In these examples, a link direction of the symbol may be configured or determined based at least in part on the configured uplink transmission or downlink reception, or based at least in part on the flexible symbol when the symbol is the SBFD symbol.

In some aspects, the plurality of CCs may be associated with a reference cell and a non-reference cell. The non-reference cell may be a TDD cell. The reference cell being associated with an SBFD symbol and the TDD cell being associated with an uplink symbol may be an error case for intra-band CA. In some aspects, the plurality of CCs may be associated with a reference cell and a non-reference cell. The non-reference cell may be an SBFD cell. The reference cell being associated with an uplink symbol and the SBFD cell being associated with an SBFD symbol may be an error case for intra-band CA.

In some aspects, collision scenarios may be defined for downlink/uplink symbols versus SBFD symbols. For HD CA, a conflict between uplink/downlink symbols in a reference cell versus uplink/downlink symbols on other cells may or may not be allowed for intra-band CA and inter-band CA in accordance with a set of rules, where the set of rules may be extended when one or more cells are SBFD cells. An SBFD symbol may not be introduced in an uplink symbol to avoid inter-network-node CLI to a legacy TDD operation. In some aspects, when another cell among serving cells configured with directional collision handling operates in the same frequency band as a reference cell, the UE may not expect a symbol to be indicated as uplink on the reference cell and as an SBFD symbol on the other cell. Additionally, the UE may not expect a symbol to be indicated as an SBFD symbol on the reference cell and as an uplink symbol on the other cell.

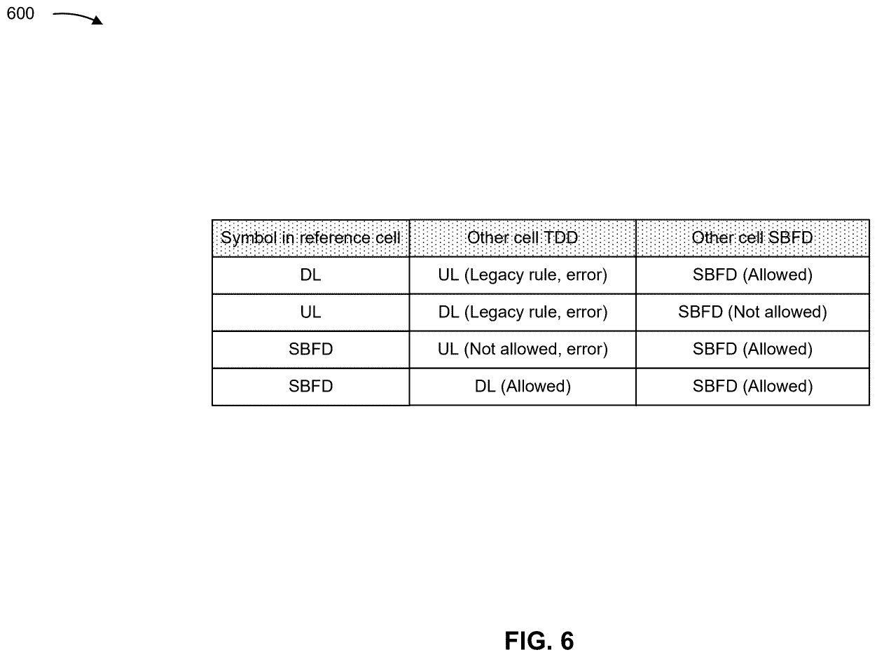

In some aspects, collision scenarios may be defined for downlink/uplink symbols versus SBFD symbols (e.g., as shown in FIG. 6). A conflict between a downlink symbol in a reference cell and an uplink symbol in another cell (e.g., TDD cell) may not be allowed and may result in an error. A conflict between an uplink symbol in a reference cell and a downlink symbol in another cell (e.g., TDD cell) may not be allowed and may result in an error. A conflict between an SBFD symbol in a reference cell and an uplink symbol in another cell (e.g., TDD cell) may not be allowed and may result in an error. A conflict between an SBFD symbol in a reference cell and a downlink symbol in another cell (e.g., TDD cell) may be allowed.

In some aspects, a conflict between a downlink symbol in a reference cell and an SBFD symbol in another cell (e.g., SBFD cell) may be allowed. A conflict between an uplink symbol in a reference cell and an SBFD symbol in another cell (e.g., SBFD cell) may not be allowed and may result in an error. A conflict between an SBFD symbol in a reference cell and an SBFD symbol in another cell (e.g., SBFD cell) may be allowed. A conflict between an SBFD symbol in a reference cell and an SBFD symbol in another cell (e.g., SBFD cell) may be allowed.

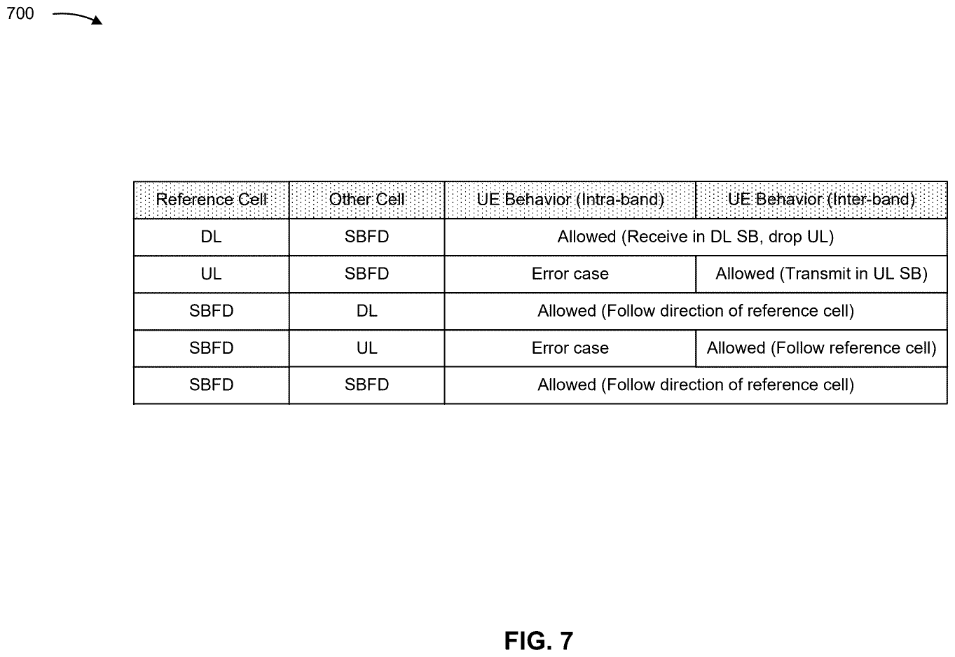

In some aspects, collision scenarios may be defined for various symbol types (e.g., as shown in FIG. 7). The different symbol types may be for intra-band CA and inter-band CA with an SBFD operation at least in one of the cells. In a first scenario, a downlink symbol in a reference cell and an SBFD symbol in another cell may be allowed for intra-band CA and inter-band CA. A UE behavior for intra-band CA may involve receiving in a downlink subband and dropping an uplink subband. A UE behavior for inter-band CA may involve receiving in a downlink subband and dropping an uplink subband. In a second scenario, an uplink symbol in a reference cell and an SBFD symbol in another cell may result in an error case for intra-band CA and may be allowed for inter-band CA. A UE behavior for inter-band CA may involve transmitting in an uplink subband. In a third scenario, an SBFD symbol in a reference cell and a downlink symbol in another cell may be allowed for intra-band CA and inter-band CA. A UE behavior for intra-band CA may involve following a direction of the reference cell. A UE behavior for inter-band CA may involve following a direction of the reference cell. In a fourth scenario, an SBFD symbol in a reference cell and an uplink symbol in another cell may result in an error case for intra-band CA and may be allowed for inter-band CA. A UE behavior for inter-band CA may involve following a direction of the reference cell. In a fifth scenario, an SBFD symbol in a reference cell and an SBFD symbol in another cell may be allowed for intra-band CA and inter-band CA. A UE behavior for intra-band CA may involve following a direction of the reference cell. A UE behavior for inter-band CA may involve following a direction of the reference cell.

In some aspects, the set of collision handling rules may define one or more UE behaviors based at least in part on collisions between downlink or uplink transmissions configured by a higher layer (e.g., RRC downlink or RRC uplink) in one cell and SBFD symbols in another cell. In some aspects, a symbol may correspond to an RRC based downlink transmission on a reference cell and the symbol may be indicated as an SBFD symbol on a non-reference cell. The collision handling may include treating the SBFD symbol as a flexible symbol. The collision handling may include treating the SBFD symbol as a downlink symbol. The collision handling may be based at least in part on a scheduling in the SBFD symbol. In some aspects, an RRC downlink/uplink symbol may be associated with an uplink transmission (or downlink reception) configured by a higher layer (e.g., RRC) in the symbol.

In some aspects, collision scenarios may be defined for RRC downlink/uplink transmission in one cell versus SBFD symbols in another cell. In some aspects, for a symbol corresponding to a PDCCH transmission, PDSCH transmission, or CSI-RS transmission that is configured by higher layers on a reference cell and the symbol is indicated as an SBFD symbol on another cell, the UE may assume the symbol as a flexible symbol. The UE may assume the symbol as a downlink symbol (e.g., follow an RRC downlink direction). The UE may not transmit an SRS transmission, PUCCH transmission, PUSCH transmission, or PRACH transmission that is configured by higher layers on a set of SBFD symbols on another cell when at least one symbol of the uplink transmission overlaps with the symbol of the PDCCH transmission, PDSCH transmission, or CSI-RS transmission. In some scenarios, e.g., for intra-band CA, the UE may not expect to be configured by higher layers to receive a PDCCH transmission, PDSCH transmission, or CSI-RS transmission on a symbol on the reference cell and to detect a DCI format scheduling an uplink transmission on the symbol on another cell or when the UE does not have sufficient time to switch between an uplink transmission and a downlink reception. In some other scenario, e.g., for inter-band CA, the UE may not be required to receive a higher layer configured PDCCH transmission, PDSCH transmission, or CSI-RS transmission on flexible symbols on the reference cell in a set of symbols, when the UE detects a DCI format scheduling a transmission on one or more SBFD symbols in the set of symbols on another cell.

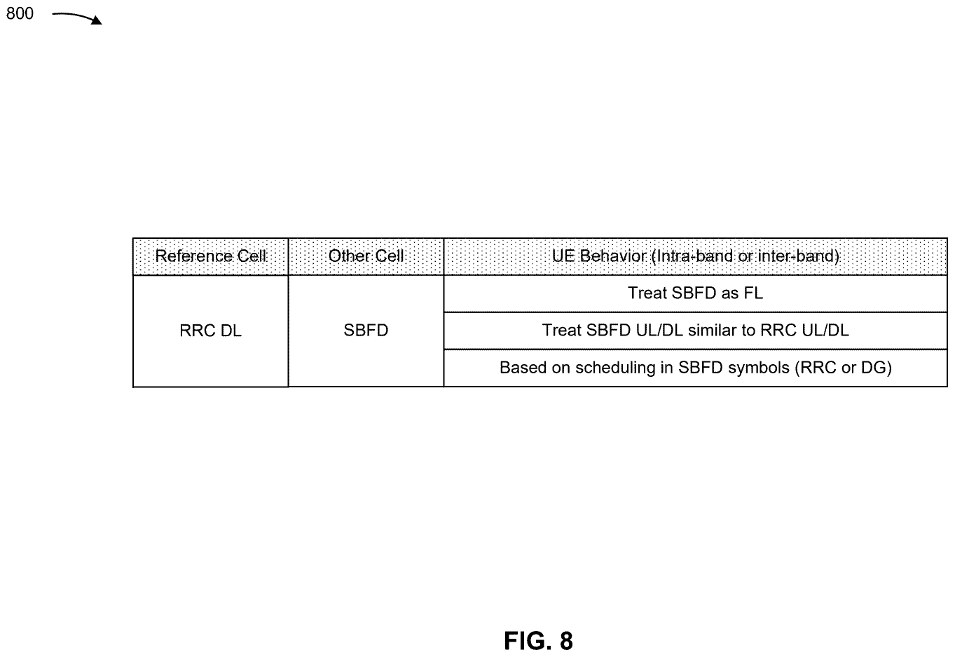

In some aspects, an RRC downlink symbol in the reference cell and an SBFD symbol in another cell may correspond to a UE behavior for intra-band CA or inter-band CA (e.g., as shown in FIG. 8). The UE behavior may involve treating the SBFD symbol as a flexible symbol. The UE behavior may involve treating an SBFD uplink/downlink symbol similar to an RRC uplink/downlink symbol. The UE behavior may be based at least in part on a scheduling in SBFD symbols (e.g., RRC scheduling or DG scheduling).

In some aspects, a symbol may correspond to an RRC based uplink transmission on a reference cell and the symbol may be indicated as an SBFD symbol on a non-reference cell. The collision handling may include treating the SBFD symbol as a flexible symbol. The collision handling may include treating the SBFD symbol as an uplink symbol. The collision handling may be based at least in part on a scheduling in the SBFD symbol.

In some aspects, for a symbol corresponding to an SRS transmission, PUCCH transmission, PUSCH transmission, or PRACH transmission that is configured by higher layers on a reference cell and the symbol is indicated as SBFD symbols on another cell, the UE may assume the symbol as a flexible symbol. The UE may assume the symbol as an uplink symbol (e.g., follow an RRC uplink direction). The UE may not receive a PDCCH transmission, PDSCH transmission, or CSI-RS transmission that is configured by higher layers on a set of SBFD symbols on another cell when at least one symbol of a downlink reception overlaps the symbol of an SRS transmission, PUCCH transmission, PUSCH transmission, or PRACH transmission or when the UE does not have sufficient time to switch between an uplink transmission and a downlink reception. The UE may not expect to be configured by higher layers to transmit an SRS transmission, PUCCH transmission, PUSCH transmission, or PRACH transmission on a flexible symbol on the reference cell and to detect a DCI format scheduling a reception on the SBFD symbol on another cell.

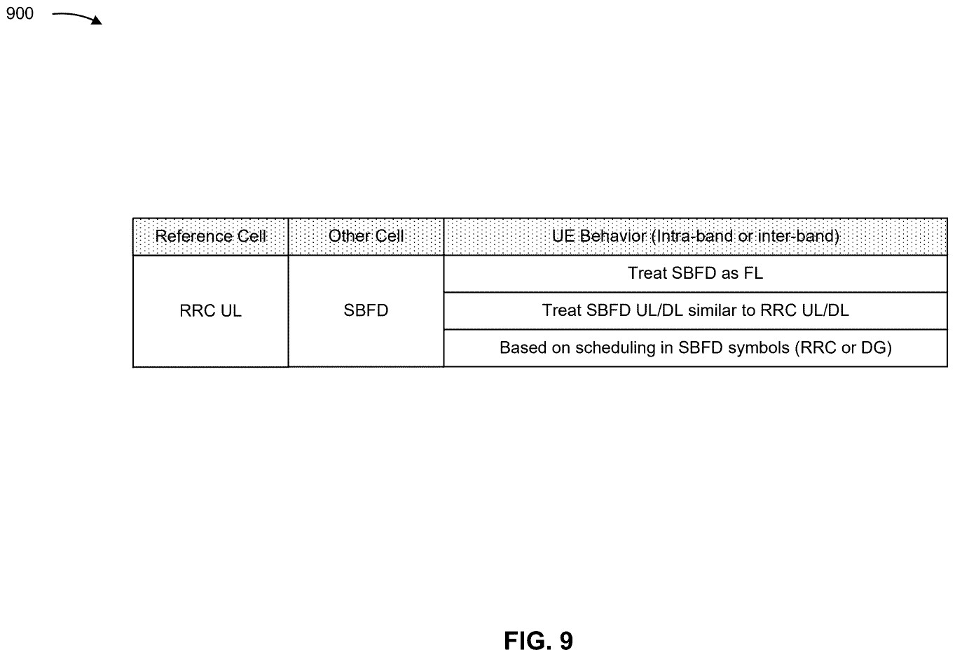

In some aspects, an RRC uplink symbol in the reference cell and an SBFD symbol in another cell may correspond to a UE behavior for intra-band CA or inter-band CA (e.g., as shown in FIG. 9). The UE behavior may involve treating the SBFD symbol as a flexible symbol. The UE behavior may involve treating an SBFD uplink/downlink symbol similar to an RRC uplink/downlink symbol. The UE behavior may be based at least in part on a scheduling in SBFD symbols (e.g., RRC scheduling or DG scheduling).

In some aspects, a symbol may be configured as an SBFD symbol on a reference cell and an RRC based uplink transmission may be configured on a non-reference cell at the same symbol. The collision handling may include dropping the RRC based uplink transmission.

In some aspects, for a symbol configured as an SBFD symbol on a reference cell and when the UE is configured by a higher layer to transmit an SRS transmission, PUCCH transmission, PUSCH transmission, or PRACH transmission on another cell, the UE may not transmit a PUCCH transmission, PUSCH transmission, or PRACH transmission that is configured by higher layers on a set of symbols on another cell when at least one symbol from the set of symbols is a symbol corresponding to a PDCCH transmission, PDSCH transmission, or CSI-RS transmission that is configured by higher layers on the reference cell, or an SBFD symbol may be semi-statically configured as downlink, or the UE may detect a DCI for downlink reception on SBFD symbols or when the UE does not have sufficient time to switch between an uplink transmission and a downlink reception. The UE may not transmit an SRS transmission on conflicting symbols.

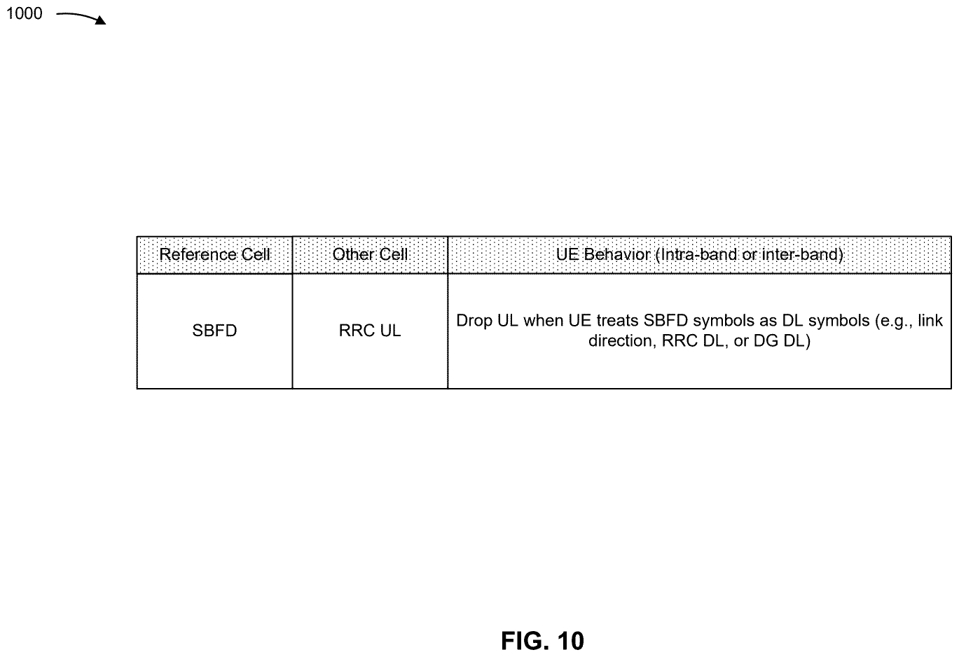

In some aspects, an SBFD symbol in the reference cell and an RRC uplink symbol in another cell may correspond to a UE behavior for intra-band CA or inter-band CA (e.g., as shown in FIG. 10). The UE behavior may involve dropping the RRC uplink symbol in the other cell when the UE treats the SBFD symbol as a downlink symbol (e.g., link direction, RRC downlink transmission, or DG downlink transmission).

In some aspects, a symbol may be configured as an SBFD symbol on a reference cell and an RRC based downlink transmission may be configured on a non-reference cell. The collision handling may include dropping the RRC based downlink transmission.

In some aspects, for a symbol configured as an SBFD symbol on a reference cell and when the UE is configured by a higher layer to receive a PDCCH transmission, PDSCH transmission, or CSI-RS transmission on another cell, the UE may not receive a downlink signal/channel that is configured by higher layers on a set of symbols on another cell when at least one symbol from the set of symbols is a symbol corresponding to an SRS transmission, PUCCH transmission, or PUSCH transmission that is configured by higher layers on the reference cell, or one SBFD symbol may be semi-statically configured as uplink, or the UE may detect a DCI for uplink transmission on SBFD symbols.

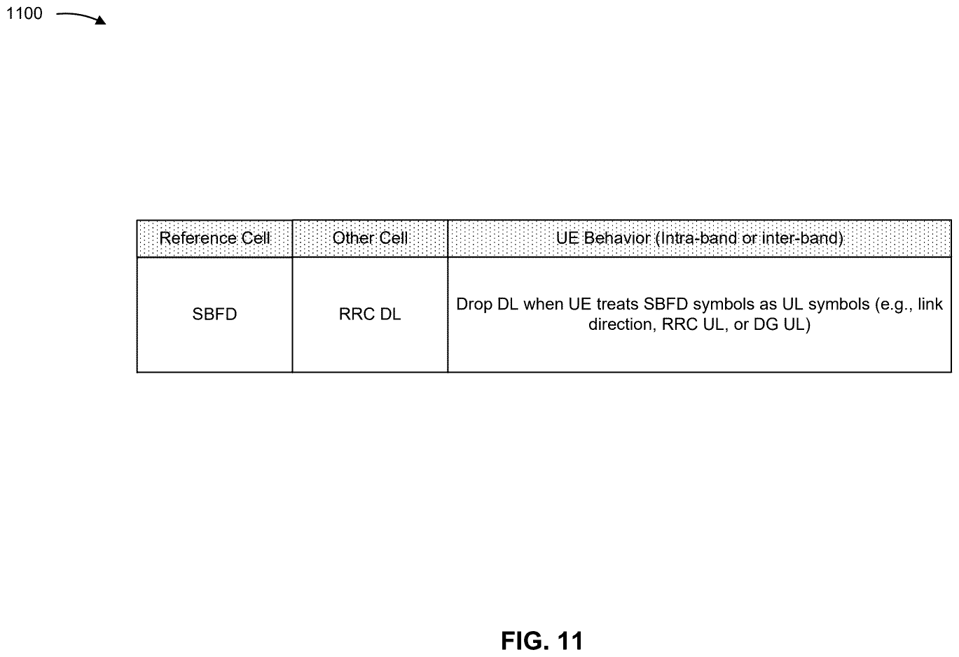

In some aspects, an SBFD symbol in the reference cell and an RRC downlink symbol in another cell may correspond to a UE behavior for intra-band CA or inter-band CA (e.g., as shown in FIG. 11). The UE behavior may involve dropping the RRC downlink symbol in the other cell when the UE treats the SBFD symbol as an uplink symbol (e.g., link direction, RRC uplink transmission, or DG uplink transmission).

In some aspects, collision scenarios may be defined for a DG downlink/uplink transmission (e.g., triggered dynamically DCI) in symbols in one cell versus SBFD symbols in another cell. A DG uplink transmission in a reference cell and an SBFD symbol in another cell may correspond to a UE behavior for intra-band CA or inter-band CA. The UE behavior may involve a UE transmitting an uplink transmission scheduled by DCI associated with the reference cell. The UE may not expect to receive DCI scheduling a downlink transmission in other SBFD cell.

In some aspects, a DG downlink transmission in one symbol of a reference cell and an SBFD symbol in another cell may correspond to a UE behavior for intra-band CA or inter-band CA. The UE behavior may involve a UE receiving a downlink transmission scheduled by DCI associated with the reference cell. Additionally, the UE may not expect to receive DCI scheduling an uplink transmission in the other SBFD cell in the same symbol of the downlink reception triggered by DCI in the reference cell.

In some aspects, an SBFD symbol in a reference cell and a DG uplink transmission in another cell may correspond to a UE behavior for intra-band CA or inter-band CA. The UE behavior may involve a UE transmitting an uplink transmission scheduled by DCI. The UE may not receive a downlink transmission configured by a higher layer on the reference cell. The UE may not expect to receive DCI scheduling a downlink transmission on the reference cell and DCI scheduling an uplink transmission on the other cell at the same symbol. When the UE is scheduled or configured to receive a downlink transmission on SBFD symbols (e.g., uplink transmission scheduled by DCI or configured by higher layers), an error may result when the UE is scheduled to transmit an uplink transmission scheduled by DCI on the reference cell.

In some aspects, a symbol may be configured as an SBFD symbol on a non-reference cell and DCI scheduling an uplink transmission on a reference cell may be detected. The uplink transmission that is scheduled by the DCI may be transmitted on the reference cell. In some aspects, a symbol may be configured as an SBFD symbol on a non-reference cell and DCI scheduling a downlink transmission on a reference cell may be detected. The downlink transmission that is scheduled by the DCI may be transmitted on the reference cell.

In some aspects, for a symbol configured as an SBFD symbol on another cell and when the UE detects a DCI scheduling an uplink transmission on a reference cell, the UE may transmit an SRS transmission, PUCCH transmission, PUSCH transmission, or PRACH transmission scheduled by the DCI at the reference cell. The UE may not expect to receive DCI scheduling a downlink transmission in the other SBFD cell. The UE may not receive a CSI-RS transmission, PDCCH transmission, or PDSCH transmission configured by a higher layer in a downlink subband of the SBFD symbol.

In some aspects, for a symbol configured as an SBFD symbol on another cell and when the UE detects a DCI scheduling a downlink reception on the reference cell, the UE may receive a CSI-RS transmission, PDCCH transmission, or PDSCH transmission scheduled by the DCI at the reference cell. The UE may not expect to receive DCI scheduling an uplink transmission in the other SBFD cell. The UE may not transmit an SRS transmission, PUCCH transmission, or PUSCH transmission configured by higher layer in an uplink subband of the SBFD symbol on the other cell.

In some aspects, a symbol may be configured as an SBFD symbol on a reference cell and DCI scheduling an uplink transmission at the same symbol on a non-reference cell may be detected. The uplink transmission that is scheduled by the DCI may be transmitted on the non-reference cell based at least in part on the UE not being scheduled or configured with a downlink transmission on the reference cell. In some aspects, a symbol may be configured as an SBFD symbol on a reference cell and DCI scheduling a downlink transmission on a non-reference cell may be detected. The downlink transmission that is scheduled by the DCI may be transmitted on the non-reference cell based at least in part on the UE not being scheduled or configured with an uplink transmission on the reference cell.

In some aspects, for a symbol configured as an SBFD symbol on a reference cell and when the UE detects a DCI scheduling an uplink transmission on another cell at the same symbol, the UE may transmit an SRS transmission, PUCCH transmission, PUSCH transmission, or PRACH transmission scheduled by the DCI at the other cell when the UE is not scheduled or configured with a downlink reception at an SBFD cell. Otherwise, the UE may not expect to receive DCI scheduling a downlink transmission in the SBFD symbol on the reference cell and another DCI scheduling an uplink transmission on another other cell at the same symbol. For an RRC downlink transmission (e.g., configured by a higher layer) on the reference cell versus a downlink/uplink symbol on another cell, the UE may not receive a downlink configuration configured by a higher layer on the reference cell (e.g., for inter-band CA) when the UE detects DCI scheduling uplink transmission on the same symbol in the non-reference cell. The UE may not expect to receive a downlink transmission configured by a higher layer on the reference cell (e.g., for intra-band CA).

In some aspects, for a symbol configured as an SBFD symbol on a reference cell and when the UE detects a DCI scheduling a downlink reception on another cell, the UE may receive a CSI-RS transmission, PDCCH transmission, or PDSCH transmission scheduled by the DCI at another cell when the UE is not configured or scheduled with an uplink transmission on an SBFD cell. Otherwise, the UE may not expect to receive DCI scheduling an uplink transmission in the SBFD cell and DCI scheduling a downlink transmission on another cell. For an RRC uplink transmission n the reference cell, the UE may not transmit an SRS transmission, PUCCH transmission, or PUSCH transmission configured by higher layer in an uplink subband of the SBFD symbol on the reference cell when the UE detects a DCI scheduling downlink reception on another cell.

In some aspects, the UE may perform the collision handling based at least in part on a collision that occurs between a downlink transmission in a non-reference cell and a valid RO in an SBFD symbol in a reference cell.

In some aspects, collision scenarios may be defined for a valid RO in an SBFD symbol in a reference/other cell versus a downlink reception in another cell. In a first case, a PDCCH order versus a DG PDSCH transmission may result in an error case. The UE may not expect a collision between a PRACH transmission triggered by the PDCCH order and a dynamically scheduled downlink reception. In a second case, a PDCCH order versus a semi-static PDSCH transmission may result in a PRACH transmission being prioritized and a downlink transmission being dropped. In other words, for a collision between a PRACH transmission triggered by the PDCCH order and a semi-statically configured downlink reception, the UE may not receive a downlink channel/signal. In a third case, a PRACH transmission triggered by a higher layer versus a downlink transmission may depend on a UE implementation. For collision between a PRACH transmission triggered by a higher layer and a downlink channel/signal, the UE may transmit the PRACH transmission or receive the downlink channel/signal based at least in part on the UE implementation.

As shown by reference number 506 in FIG. 5, the network node may detect the collision handling between the first transmission associated with the first CC and the second transmission associated with the second CC based at least in part on the set of collision handling rules. In some cases, the network node may configure the UE with the set of collision handling rules. The network node may be aware of collision handling performed by the UE. The network node may be aware when the collision handling includes transmitting the first transmission and dropping the second transmission based at least in part on the set of collision handling rules. The network node may be aware when the collision handling includes transmitting the second transmission and dropping the first transmission based at least in part on the set of collision handling rules.

As indicated above, FIG. 5 is provided as an example. Other examples may differ from what is described with regard to FIG. 5.

FIG. 6 is a diagram illustrating an example 600 associated with collision handling between transmissions associated with CA and SBFD.

As shown in FIG. 6, conflicts may occur between reference cells and other cells (e.g., TDD cells or SBFD cells). A conflict between a downlink symbol in a reference cell and an uplink symbol in another cell (e.g., TDD cell) may not be allowed and may result in an error. A conflict between an uplink symbol in a reference cell and a downlink symbol in another cell (e.g., TDD cell) may not be allowed and may result in an error. A conflict between an SBFD symbol in a reference cell and an uplink symbol in another cell (e.g., TDD cell) may not be allowed and may result in an error. A conflict between an SBFD symbol in a reference cell and a downlink symbol in another cell (e.g., TDD cell) may be allowed.

As further shown in FIG. 6, a conflict between a downlink symbol in a reference cell and an SBFD symbol in another cell (e.g., SBFD cell) may be allowed. A conflict between an uplink symbol in a reference cell and an SBFD symbol in another cell (e.g., SBFD cell) may not be allowed and may result in an error. A conflict between an SBFD symbol in a reference cell and an SBFD symbol in another cell (e.g., SBFD cell) may be allowed. A conflict between an SBFD symbol in a reference cell and an SBFD symbol in another cell (e.g., SBFD cell) may be allowed.

As indicated above, FIG. 6 is provided as an example. Other examples may differ from what is described with regard to FIG. 6.

FIG. 7 is a diagram illustrating an example 700 associated with collision handling between transmissions associated with CA and SBFD.

As shown in FIG. 7, in a first scenario, a downlink symbol in a reference cell and an SBFD symbol in another cell may be allowed for intra-band CA and inter-band CA. A UE behavior for intra-band CA may involve receiving in a downlink subband and dropping an uplink subband. A UE behavior for inter-band CA may involve receiving in a downlink subband and dropping an uplink subband. In a second scenario, an uplink symbol in a reference cell and an SBFD symbol in another cell may result in an error case for intra-band CA and may be allowed for inter-band CA. A UE behavior for inter-band CA may involve transmitting in an uplink subband. In a third scenario, an SBFD symbol in a reference cell and a downlink symbol in another cell may be allowed for intra-band CA and inter-band CA. A UE behavior for intra-band CA may involve following a direction of the reference cell. A UE behavior for inter-band CA may involve following a direction of the reference cell. In a fourth scenario, an SBFD symbol in a reference cell and an uplink symbol in another cell may result in an error case for intra-band CA and may be allowed for inter-band CA. A UE behavior for inter-band CA may involve following a direction of the reference cell. In a fifth scenario, an SBFD symbol in a reference cell and an SBFD symbol in another cell may be allowed for intra-band CA and inter-band CA. A UE behavior for intra-band CA may involve following a direction of the reference cell. A UE behavior for inter-band CA may involve following a direction of the reference cell.

As indicated above, FIG. 7 is provided as an example. Other examples may differ from what is described with regard to FIG. 7.

FIG. 8 is a diagram illustrating an example 800 associated with collision handling between transmissions associated with CA and SBFD.

As shown in FIG. 8, an RRC downlink transmission (e.g., downlink reception configured by a higher layer) in the reference cell and an SBFD symbol in another cell may correspond to a UE behavior for intra-band CA or inter-band CA. The UE behavior may involve treating the SBFD symbol as a flexible symbol. The UE behavior may involve treating an SBFD uplink/downlink symbol similar to an RRC uplink/downlink symbol. The UE behavior may be based at least in part on a scheduling in SBFD symbols (e.g., RRC scheduling or DG scheduling).

As indicated above, FIG. 8 is provided as an example. Other examples may differ from what is described with regard to FIG. 8.

FIG. 9 is a diagram illustrating an example 900 associated with collision handling between transmissions associated with CA and SBFD.

As shown in FIG. 9, an RRC uplink transmission (e.g., uplink transmission configured by a higher layer) in the reference cell and an SBFD symbol in another cell may correspond to a UE behavior for intra-band CA or inter-band CA. The UE behavior may involve treating the SBFD symbol as a flexible symbol. The UE behavior may involve treating an SBFD uplink/downlink symbol similar to an RRC uplink/downlink transmission. The UE behavior may be based at least in part on a scheduling in SBFD symbols (e.g., RRC scheduling or DG scheduling) and collision handling rules in SBFD symbols.

As indicated above, FIG. 9 is provided as an example. Other examples may differ from what is described with regard to FIG. 9.

FIG. 10 is a diagram illustrating an example 1000 associated with collision handling between transmissions associated with CA and SBFD.

As shown in FIG. 10, an SBFD symbol in the reference cell and an RRC uplink transmission in another cell may correspond to a UE behavior for intra-band CA or inter-band CA. The UE behavior may involve dropping the RRC uplink symbol in the other cell when the UE treats the SBFD symbol as a downlink symbol (e.g., link direction, RRC downlink transmission, or DG downlink transmission).

As indicated above, FIG. 10 is provided as an example. Other examples may differ from what is described with regard to FIG. 10.

FIG. 11 is a diagram illustrating an example 1100 associated with collision handling between transmissions associated with CA and SBFD.

As shown in FIG. 11, an SBFD symbol in the reference cell and an RRC downlink symbol in another cell may correspond to a UE behavior for intra-band CA or inter-band CA. The UE behavior may involve dropping the RRC downlink symbol in the other cell when the UE treats the SBFD symbol as an uplink symbol (e.g., link direction, RRC uplink transmission, or DG uplink transmission).

As indicated above, FIG. 11 is provided as an example. Other examples may differ from what is described with regard to FIG. 11.

FIG. 12 is a diagram illustrating an example process 1200 performed, for example, at a UE or an apparatus of a UE. Example process 1200 is an example where the apparatus or the UE (e.g., UE 120) performs operations associated with collision handling between transmissions associated with CA and SBFD.

As shown in FIG. 12, in some aspects, process 1200 may include receiving a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs (block 1210). For example, the UE (e.g., using reception component 1402 or communication manager 1406, depicted in FIG. 14) may receive a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs, as described above.

As further shown in FIG. 12, in some aspects, process 1200 may include performing a collision handling between a first transmission associated with the first CC and a second transmission associated with the second CC based at least in part on a set of collision handling rules (block 1220). For example, the UE (e.g., using communication manager 1406, depicted in FIG. 14) may perform a collision handling between a first transmission associated with the first CC and a second transmission associated with the second CC based at least in part on a set of collision handling rules, as described above.

Process 1200 may include additional aspects, such as any single aspect or any combination of aspects described below or in connection with one or more other processes described elsewhere herein.

In a first aspect, the first transmission is an uplink transmission, the second transmission is a downlink transmission, and the second CC is associated with TDD or SBFD; or the first transmission is a downlink transmission, the second transmission is an uplink transmission, and the second CC is associated with SBFD.

In a second aspect, alone or in combination with the first aspect, process 1200 includes transmitting the first transmission and dropping the second transmission based at least in part on the set of collision handling rules, or transmitting the second transmission and dropping the first transmission based at least in part on the set of collision handling rules.

In a third aspect, alone or in combination with one or more of the first and second aspects, the plurality of CCs is associated with a reference cell and a non-reference cell, wherein the reference cell is an active cell with a lowest cell index among a plurality of cells associated with the plurality of CCs, and a symbol associated with the reference cell is indicated as an SBFD symbol and is based at least in part on a configured uplink transmission or a configured downlink reception.

In a fourth aspect, alone or in combination with one or more of the first through third aspects, the symbol is a downlink symbol based at least in part on the symbol being the SBFD symbol and the UE being configured to receive a downlink transmission on the symbol.

In a fifth aspect, alone or in combination with one or more of the first through fourth aspects, the symbol is an uplink symbol based at least in part on the symbol being the SBFD symbol and the UE being configured to transmit an uplink transmission on the symbol.

In a sixth aspect, alone or in combination with one or more of the first through fifth aspects, the plurality of CCs is associated with a reference cell and a non-reference cell, wherein the reference cell is an active cell with a lowest cell index among a plurality of cells associated with the plurality of CCs, and a symbol associated with the reference cell is a flexible symbol based at least in part on the symbol being an SBFD symbol.

In a seventh aspect, alone or in combination with one or more of the first through sixth aspects, the plurality of CCs is associated with a reference cell and a non-reference cell, wherein the non-reference cell is a TDD cell, and the reference cell being associated with an SBFD symbol and the TDD cell being associated with an uplink symbol is an error case for intra-band CA.

In an eighth aspect, alone or in combination with one or more of the first through seventh aspects, the plurality of CCs is associated with a reference cell and a non-reference cell, wherein the non-reference cell is an SBFD cell, and the reference cell being associated with an uplink symbol and the SBFD cell being associated with an SBFD symbol is an error case for intra-band CA.

In a ninth aspect, alone or in combination with one or more of the first through eighth aspects, the set of collision handling rules defines one or more UE behaviors based at least in part on collisions between RRC configured downlink or uplink symbols and SBFD symbols.

In a tenth aspect, alone or in combination with one or more of the first through ninth aspects, a symbol corresponds to a downlink transmission configured by RRC on a reference cell and the symbol is indicated as an SBFD symbol on a non-reference cell, and wherein the collision handling includes treating the SBFD symbol as a flexible symbol, the collision handling includes treating the SBFD symbol as a downlink symbol, or the collision handling is based at least in part on whether an uplink scheduling in the SBFD symbol is configured by RRC or triggered dynamically by downlink control.

In an eleventh aspect, alone or in combination with one or more of the first through tenth aspects, a symbol corresponds an uplink transmission configured by RRC on a reference cell and the symbol is indicated as an SBFD symbol on a non-reference cell, and the collision handling includes treating the SBFD symbol as a flexible symbol, the collision handling includes treating the SBFD symbol as an uplink symbol, or the collision handling is based at least in part on whether a downlink scheduling in the SBFD symbol is configured by RRC or triggered by downlink control.

In a twelfth aspect, alone or in combination with one or more of the first through eleventh aspects, a symbol is configured as an SBFD symbol on a reference cell and an RRC based uplink transmission is configured on a non-reference cell, and the collision handling includes dropping the RRC based uplink transmission based at least in part on the UE being configured to receive downlink in the SBFD symbol on the reference cell.

In a thirteenth aspect, alone or in combination with one or more of the first through twelfth aspects, a symbol is configured as an SBFD symbol on a reference cell and an RRC based downlink transmission is configured on a non-reference cell, and the collision handling includes dropping the RRC based downlink transmission based at least in part on the UE being configured to transmit uplink in the SBFD symbol on the reference cell.

In a fourteenth aspect, alone or in combination with one or more of the first through thirteenth aspects, a symbol is configured as an SBFD symbol on a non-reference cell and DCI scheduling an uplink transmission on a reference cell is detected, and the uplink transmission that is scheduled by the DCI is transmitted on the reference cell and the UE is not expected to receive a downlink configured by RRC in a downlink subband of SBFD symbols on the non-reference cell.

In a fifteenth aspect, alone or in combination with one or more of the first through fourteenth aspects, a symbol is configured as an SBFD symbol on a non-reference cell and DCI scheduling a downlink transmission on a reference cell is detected, and the downlink transmission that is scheduled by the DCI is transmitted on the reference cell and the UE is not expected to transmit an uplink configured by RRC in an uplink subband of SBFD symbols on the non-reference cell.

In a sixteenth aspect, alone or in combination with one or more of the first through fifteenth aspects, a symbol is configured as an SBFD symbol on a reference cell and DCI scheduling an uplink transmission on a non-reference cell is detected, and the uplink transmission that is scheduled by the DCI is transmitted on the non-reference cell based at least in part on the UE not being scheduled or configured with a downlink transmission on the reference cell.

In a seventeenth aspect, alone or in combination with one or more of the first through sixteenth aspects, a symbol is configured as an SBFD symbol on a reference cell and DCI scheduling a downlink transmission on a non-reference cell is detected, and the downlink transmission that is scheduled by the DCI is transmitted on the non-reference cell based at least in part on the UE not being scheduled or configured with an uplink transmission on the reference cell.

In an eighteenth aspect, alone or in combination with one or more of the first through seventeenth aspects, process 1200 includes performing the collision handling based at least in part on a collision that occurs between a downlink transmission in a non-reference cell and a valid RO in an SBFD symbol in a reference cell.

In a nineteenth aspect, alone or in combination with one or more of the first through eighteenth aspects, the CA is an intra-band CA or an inter-band CA.

In a twentieth aspect, alone or in combination with one or more of the first through nineteenth aspects, the UE is an HD CA UE.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, at a network node or an apparatus of a network node. Example process 1300 is an example where the apparatus or the network node (e.g., network node 110) performs operations associated with collision handling between transmissions associated with CA and SBFD.

As shown in FIG. 13, in some aspects, process 1300 may include transmitting a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs (block 1310). For example, the network node (e.g., using transmission component 1504 or communication manager 1506, depicted in FIG. 15) may transmit a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs, as described above.

As further shown in FIG. 13, in some aspects, process 1300 may include detecting a collision handling between a first transmission associated with the first CC and a second transmission associated with the second CC based at least in part on a set of collision handling rules (block 1320). For example, the network node (e.g., using communication manager 1506, depicted in FIG. 15) may detect a collision handling between a first transmission associated with the first CC and a second transmission associated with the second CC based at least in part on a set of collision handling rules, as described above.

Process 1300 may include additional aspects, such as any single aspect or any combination of aspects described below or in connection with one or more other processes described elsewhere herein.

In a first aspect, the first transmission is an uplink transmission, the second transmission is a downlink transmission, and the second CC is associated with TDD or SBFD, or the first transmission is a downlink transmission, the second transmission is an uplink transmission, and the second CC is associated with SBFD.

In a second aspect, alone or in combination with the first aspect, the plurality of CCs is associated with a reference cell and a non-reference cell, wherein the reference cell is an active cell with a lowest cell index among a plurality of cells associated with the plurality of CCs, and a symbol associated with the reference cell is indicated as an SBFD symbol and is based at least in part on a configured uplink transmission or a configured downlink reception.

In a third aspect, alone or in combination with one or more of the first and second aspects, the symbol is a downlink symbol based at least in part on the symbol being the SBFD symbol and a UE being configured to receive a downlink transmission on the symbol.

In a fourth aspect, alone or in combination with one or more of the first through third aspects, the symbol is an uplink symbol based at least in part on the symbol being the SBFD symbol and a UE being configured to transmit an uplink transmission on the symbol.

In a fifth aspect, alone or in combination with one or more of the first through fourth aspects, the plurality of CCs is associated with a reference cell and a non-reference cell, wherein the reference cell is an active cell with a lowest cell index among a plurality of cells associated with the plurality of CCs, and a symbol associated with the reference cell is a flexible symbol based at least in part on the symbol being an SBFD symbol.

In a sixth aspect, alone or in combination with one or more of the first through fifth aspects, the plurality of CCs is associated with a reference cell and a non-reference cell, wherein the non-reference cell is a TDD cell, and the reference cell being associated with an SBFD symbol and the TDD cell being associated with an uplink symbol is an error case for intra-band CA.

In a seventh aspect, alone or in combination with one or more of the first through sixth aspects, the plurality of CCs is associated with a reference cell and a non-reference cell, wherein the non-reference cell is an SBFD cell, and the reference cell being associated with an uplink symbol and the SBFD cell being associated with an SBFD symbol is an error case for intra-band CA.

In an eighth aspect, alone or in combination with one or more of the first through seventh aspects, the set of collision handling rules defines one or more UE behaviors based at least in part on collisions between RRC configured downlink or uplink symbols and SBFD symbols.

In a ninth aspect, alone or in combination with one or more of the first through eighth aspects, a symbol corresponds to a downlink transmission configured by RRC on a reference cell and the symbol is indicated as an SBFD symbol on a non-reference cell, and the collision handling includes treating the SBFD symbol as a flexible symbol, the collision handling includes treating the SBFD symbol as a downlink symbol, or the collision handling is based at least in part on whether an uplink scheduling in the SBFD symbol is configured by RRC or triggered dynamically by downlink control.

In a tenth aspect, alone or in combination with one or more of the first through ninth aspects, a symbol corresponds an uplink transmission configured by RRC on a reference cell and the symbol is indicated as an SBFD symbol on a non-reference cell, and wherein the collision handling includes treating the SBFD symbol as a flexible symbol, the collision handling includes treating the SBFD symbol as an uplink symbol, or the collision handling is based at least in part on whether a downlink scheduling in the SBFD symbol is configured by RRC or triggered by downlink control.

In an eleventh aspect, alone or in combination with one or more of the first through tenth aspects, a symbol is configured as an SBFD symbol on a reference cell and an RRC based uplink transmission is configured on a non-reference cell, and the collision handling includes dropping the RRC based uplink transmission based at least in part on the UE being configured to receive downlink in the SBFD symbol on the reference cell.

In a twelfth aspect, alone or in combination with one or more of the first through eleventh aspects, a symbol is configured as an SBFD symbol on a reference cell and an RRC based downlink transmission is configured on a non-reference cell, and the collision handling includes dropping the RRC based downlink transmission based at least in part on the UE being configured to transmit uplink in the SBFD symbol on the reference cell.

In a thirteenth aspect, alone or in combination with one or more of the first through twelfth aspects, a symbol is configured as an SBFD symbol on a non-reference cell and DCI scheduling an uplink transmission on a reference cell is detected, and the uplink transmission that is scheduled by the DCI is transmitted on the reference cell and a UE is not expected to receive a downlink configured by radio resource control (RRC) in a downlink subband of SBFD symbols on the non-reference cell.

In a fourteenth aspect, alone or in combination with one or more of the first through thirteenth aspects, a symbol is configured as an SBFD symbol on a non-reference cell and DCI scheduling a downlink transmission on a reference cell is detected, and the downlink transmission that is scheduled by the DCI is transmitted on the reference cell and a UE is not expected to transmit an uplink configured by radio resource control (RRC) in an uplink subband of SBFD symbols on the non-reference cell.

In a fifteenth aspect, alone or in combination with one or more of the first through fourteenth aspects, a symbol is configured as an SBFD symbol on a reference cell and DCI scheduling an uplink transmission on a non-reference cell is detected, and the uplink transmission that is scheduled by the DCI is transmitted on the non-reference cell based at least in part on a UE not being scheduled or configured with a downlink transmission on the reference cell.

In a sixteenth aspect, alone or in combination with one or more of the first through fifteenth aspects, a symbol is configured as an SBFD symbol on a reference cell and DCI scheduling a downlink transmission on a non-reference cell is detected, and the downlink transmission that is scheduled by the DCI is transmitted on the non-reference cell based at least in part on a UE not being scheduled or configured with an uplink transmission on the reference cell.

In a seventeenth aspect, alone or in combination with one or more of the first through sixteenth aspects, the collision handling is based at least in part on a collision that occurs between a downlink transmission in a cell and a valid RO in an SBFD symbol in another cell.

In an eighteenth aspect, alone or in combination with one or more of the first through seventeenth aspects, the CA is an intra-band CA or an inter-band CA.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication. The apparatus 1400 may be a UE, or a UE may include the apparatus 1400. In some aspects, the apparatus 1400 includes a reception component 1402, a transmission component 1404, or a communication manager 1406, which may be in communication with one another (for example, via one or more buses or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (for example, the processing system 140 described in connection with FIG. 1) of the UE.

In some aspects, the apparatus 1400 may be configured to perform one or more operations described herein in connection with FIGS. 5-11. Additionally, or alternatively, the apparatus 1400 may be configured to perform one or more processes described herein, such as process 1200 of FIG. 12. In some aspects, the apparatus 1400 or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications, and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications, and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 or the transmission component 1404. For example, the communication manager 1406 may receive information associated with configuring reception of communications by the reception component 1402 or transmission of communications by the transmission component 1404. Additionally, or alternatively, the communication manager 1406 may generate or provide control information to the reception component 1402 or the transmission component 1404 to control reception or transmission of communications.

The reception component 1402 may receive a configuration that indicates a plurality of CCs associated with CA, wherein the plurality of CCs includes a first CC associated with SBFD and a second CC associated with TDD or SBFD, and wherein the configuration is based at least in part on a UE capability support of an HD mode among the plurality of CCs. The communication manager 1406 may perform a collision handling between a first transmission associated with the first CC and a second transmission associated with the second CC based at least in part on a set of collision handling rules.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication. The apparatus 1500 may be a network node, or a network node may include the apparatus 1500. In some aspects, the apparatus 1500 includes a reception component 1502, a transmission component 1504, or a communication manager 1506, which may be in communication with one another (for example, via one or more buses or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (for example, the processing system 145 described in connection with FIG. 1) of the network node.

In some aspects, the apparatus 1500 may be configured to perform one or more operations described herein in connection with FIGS. 5-11. Additionally, or alternatively, the apparatus 1500 may be configured to perform one or more processes described herein, such as process 1300 of FIG. 13. In some aspects, the apparatus 1500 or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 or the transmission component 1504 may include or may be included in a network interface. The network interface may be configured to obtain or output signals for the apparatus 1500 via one or more communications links, such as a backhaul link, a midhaul link, or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 or the transmission component 1504. For example, the communication manager 1506 may receive information associated with configuring reception of communications by the reception component 1502 or transmission of communications by the transmission component 1504. Additionally, or alternatively, the communication manager 1506 may generate or provide control information to the reception component 1502 or the transmission component 1504 to control reception or transmission of communications.

The transmission component 1504 may transmit a configuration that indicates a plurality of CCs associated with carrier aggregation, wherein the plurality of CCs includes a first CC associated with SBFD and a second CC associated with TDD or SBFD, and wherein the configuration is based at least in part on a UE capability support of an HD mode among the plurality of CCs. The communication manager 1506 may detect a collision handling between a first transmission associated with the first CC and a second transmission associated with the second CC based at least in part on a set of collision handling rules.

The number and arrangement of components shown in FIG. 15 are provided as an example. In practice, there may be additional components, fewer components, different components, or differently arranged components than those shown in FIG. 15.

Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:
Aspect 1: A method of wireless communication performed by a user equipment (UE), comprising: receiving a configuration that indicates a plurality of component carriers (CCs) associated with carrier aggregation (CA), wherein the plurality of CCs includes a first CC associated with subband full duplex (SBFD) and a second CC associated with time division duplexing (TDD) or SBFD, and wherein the configuration is based at least in part on a UE capability support of a half-duplex mode among the plurality of CCs; and performing a collision handling between a first transmission associated with the first CC and a second transmission associated with the second CC based at least in part on a set of collision handling rules.
Aspect 2: The method of Aspect 1, wherein: the first transmission is an uplink transmission, the second transmission is a downlink transmission, and the second CC is associated with TDD or SBFD; or the first transmission is a downlink transmission, the second transmission is an uplink transmission, and the second CC is associated with SBFD.
Aspect 3: The method of any of Aspects 1-2, wherein performing the collision handling comprises: transmitting the first transmission and dropping the second transmission based at least in part on the set of collision handling rules; or transmitting the second transmission and dropping the first transmission based at least in part on the set of collision handling rules.
Aspect 4: The method of any of Aspects 1-3, wherein the plurality of CCs is associated with a reference cell and a non-reference cell, wherein the reference cell is an active cell with a lowest cell index among a plurality of cells associated with the plurality of CCs, and wherein a symbol associated with the reference cell is indicated as an SBFD symbol and is based at least in part on a configured uplink transmission or a configured downlink reception.
Aspect 5: The method of Aspect 4, wherein the symbol is a downlink symbol based at least in part on the symbol being the SBFD symbol and the UE being configured to receive a downlink transmission on the symbol.
Aspect 6: The method of Aspect 4, wherein the symbol is an uplink symbol based at least in part on the symbol being the SBFD symbol and the UE being configured to transmit an uplink transmission on the symbol.
Aspect 7: The method of any of Aspects 1-6, wherein the plurality of CCs is associated with a reference cell and a non-reference cell, wherein the reference cell is an active cell with a lowest cell index among a plurality of cells associated with the plurality of CCs, and wherein a symbol associated with the reference cell is a flexible symbol based at least in part on the symbol being an SBFD symbol.
Aspect 8: The method of any of Aspects 1-7, wherein the plurality of CCs is associated with a reference cell and a non-reference cell, wherein the non-reference cell is a TDD cell, and wherein the reference cell being associated with an SBFD symbol and the TDD cell being associated with an uplink symbol is an error case for intra-band CA.
Aspect 9: The method of any of Aspects 1-8, wherein the plurality of CCs is associated with a reference cell and a non-reference cell, wherein the non-reference cell is an SBFD cell, and wherein the reference cell being associated with an uplink symbol and the SBFD cell being associated with an SBFD symbol is an error case for intra-band CA.
Aspect 10: The method of any of Aspects 1-9, wherein the set of collision handling rules defines one or more UE behaviors based at least in part on collisions between radio resource control (RRC) based downlink or uplink symbols and SBFD symbols.
Aspect 11: The method of any of Aspects 1-10, wherein a symbol corresponds to a downlink transmission configured by radio resource control (RRC) on a reference cell and the symbol is indicated as an SBFD symbol on a non-reference cell, and wherein the collision handling includes treating the SBFD symbol as a flexible symbol, the collision handling includes treating the SBFD symbol as a downlink symbol, or the collision handling is based at least in part on whether an uplink scheduling in the SBFD symbol is configured by RRC or triggered dynamically by downlink control.
Aspect 12: The method of any of Aspects 1-11, wherein a symbol corresponds an uplink transmission configured by radio resource control (RRC) on a reference cell and the symbol is indicated as an SBFD symbol on a non-reference cell, and wherein the collision handling includes treating the SBFD symbol as a flexible symbol, the collision handling includes treating the SBFD symbol as an uplink symbol, or the collision handling is based at least in part on whether a downlink scheduling in the SBFD symbol is configured by RRC or triggered by downlink control.
Aspect 13: The method of any of Aspects 1-12, wherein a symbol is configured as an SBFD symbol on a reference cell and a radio resource control (RRC) based uplink transmission is configured on a non-reference cell, and wherein the collision handling includes dropping the RRC based uplink transmission based at least in part on the UE being configured to receive downlink in the SBFD symbol on the reference cell.
Aspect 14: The method of any of Aspects 1-13, wherein a symbol is configured as an SBFD symbol on a reference cell and a radio resource control (RRC) based downlink transmission is configured on a non-reference cell, and wherein the collision handling includes dropping the RRC based downlink transmission based at least in part on the UE being configured to transmit uplink in the SBFD symbol on the reference cell.
Aspect 15: The method of any of Aspects 1-14, wherein a symbol is configured as an SBFD symbol on a non-reference cell and downlink control information (DCI) scheduling an uplink transmission on a reference cell is detected, and wherein the uplink transmission that is scheduled by the DCI is transmitted on the reference cell and the UE is not expected to receive a downlink configured by radio resource control (RRC) in a downlink subband of SBFD symbols on the non-reference cell.
Aspect 16: The method of any of Aspects 1-15, wherein a symbol is configured as an SBFD symbol on a non-reference cell and downlink control information (DCI) scheduling a downlink transmission on a reference cell is detected, and wherein the downlink transmission that is scheduled by the DCI is transmitted on the reference cell and the UE is not expected to transmit an uplink configured by radio resource control (RRC) in an uplink subband of SBFD symbols on the non-reference cell.
Aspect 17: The method of any of Aspects 1-16, wherein a symbol is configured as an SBFD symbol on a reference cell and downlink control information (DCI) scheduling an uplink transmission on a non-reference cell is detected, and wherein the uplink transmission that is scheduled by the DCI is transmitted on the non-reference cell based at least in part on the UE not being scheduled or configured with a downlink transmission on the reference cell.
Aspect 18: The method of any of Aspects 1-17, wherein a symbol is configured as an SBFD symbol on a reference cell and downlink control information (DCI) scheduling a downlink transmission on a non-reference cell is detected, and wherein the downlink transmission that is scheduled by the DCI is transmitted on the non-reference cell based at least in part on the UE not being scheduled or configured with an uplink transmission on the reference cell.
Aspect 19: The method of any of Aspects 1-18, wherein performing the collision handling is based at least in part on a collision that occurs between a downlink transmission in a cell and a valid random access channel occasion (RO) in an SBFD symbol in another cell.
Aspect 20: The method of any of Aspects 1-19, wherein the CA is an intra-band CA or an inter-band CA.
Aspect 21: The method of any of Aspects 1-20, wherein the UE is a half-duplex CA UE.
Aspect 22: A method of wireless communication performed by a network node, comprising: transmitting a configuration that indicates a plurality of component carriers (CCs) associated with carrier aggregation (CA), wherein the plurality of CCs includes a first CC associated with subband full duplex (SBFD) and a second CC associated with time division duplexing (TDD) or SBFD, and wherein the configuration is based at least in part on a user equipment (UE) capability support of a half-duplex mode among the plurality of CCs; and detecting a collision handling between a first transmission associated with the first CC and a second transmission associated with the second CC based at least in part on a set of collision handling rules.
Aspect 23: The method of Aspect 22, wherein: the first transmission is an uplink transmission, the second transmission is a downlink transmission, and the second CC is associated with TDD or SBFD; or the first transmission is a downlink transmission, the second transmission is an uplink transmission, and the second CC is associated with SBFD.
Aspect 24: The method of any of Aspects 22-23, wherein the plurality of CCs is associated with a reference cell and a non-reference cell, wherein the reference cell is an active cell with a lowest cell index among a plurality of cells associated with the plurality of CCs, and wherein a symbol associated with the reference cell is indicated as an SBFD symbol and is based at least in part on a configured uplink transmission or a configured downlink reception.
Aspect 25: The method of Aspect 24, wherein the symbol is a downlink symbol based at least in part on the symbol being the SBFD symbol and a UE being configured to receive a downlink transmission on the symbol.
Aspect 26: The method of Aspect 24, wherein the symbol is an uplink symbol based at least in part on the symbol being the SBFD symbol and a UE being configured to transmit an uplink transmission on the symbol.
Aspect 27: The method of any of Aspects 22-26, wherein the plurality of CCs is associated with a reference cell and a non-reference cell, wherein the reference cell is an active cell with a lowest cell index among a plurality of cells associated with the plurality of CCs, and wherein a symbol associated with the reference cell is a flexible symbol based at least in part on the symbol being an SBFD symbol.
Aspect 28: The method of any of Aspects 22-27, wherein the plurality of CCs is associated with a reference cell and a non-reference cell, wherein the non-reference cell is a TDD cell, and wherein the reference cell being associated with an SBFD symbol and the TDD cell being associated with an uplink symbol is an error case for intra-band CA.
Aspect 29: The method of any of Aspects 22-28, wherein the plurality of CCs is associated with a reference cell and a non-reference cell, wherein the non-reference cell is an SBFD cell, and wherein the reference cell being associated with an uplink symbol and the SBFD cell being associated with an SBFD symbol is an error case for intra-band CA.
Aspect 30: The method of any of Aspects 22-29, wherein the set of collision handling rules defines one or more UE behaviors based at least in part on collisions between radio resource control (RRC) based downlink or uplink symbols and SBFD symbols.
Aspect 31: The method of any of Aspects 22-30, wherein a symbol corresponds to a downlink transmission configured by radio resource control (RRC) on a reference cell and the symbol is indicated as an SBFD symbol on a non-reference cell, and wherein the collision handling includes treating the SBFD symbol as a flexible symbol, the collision handling includes treating the SBFD symbol as a downlink symbol, or the collision handling is based at least in part on whether an uplink scheduling in the SBFD symbol is configured by RRC or triggered dynamically by downlink control.
Aspect 32: The method of any of Aspects 22-31, wherein a symbol corresponds an uplink transmission configured by radio resource control (RRC) on a reference cell and the symbol is indicated as an SBFD symbol on a non-reference cell, and wherein the collision handling includes treating the SBFD symbol as a flexible symbol, the collision handling includes treating the SBFD symbol as an uplink symbol, or the collision handling is based at least in part on whether a downlink scheduling in the SBFD symbol is configured by RRC or triggered by downlink control.
Aspect 33: The method of any of Aspects 22-32, wherein a symbol is configured as an SBFD symbol on a reference cell and a radio resource control (RRC) based uplink transmission is configured on a non-reference cell, and wherein the collision handling includes dropping the RRC based uplink transmission based at least in part on a UE being configured to receive downlink in the SBFD symbol on the reference cell.
Aspect 34: The method of any of Aspects 22-33, wherein a symbol is configured as an SBFD symbol on a reference cell and a radio resource control (RRC) based downlink transmission is configured on a non-reference cell, and wherein the collision handling includes dropping the RRC based downlink transmission based at least in part on a UE is configured to transmit uplink in the SBFD symbol on the reference cell.
Aspect 35: The method of any of Aspects 22-34, wherein a symbol is configured as an SBFD symbol on a non-reference cell and downlink control information (DCI) scheduling an uplink transmission on a reference cell is detected, and wherein the uplink transmission that is scheduled by the DCI is transmitted on the reference cell and a UE is not expected to receive a downlink configured by radio resource control (RRC) in a downlink subband of SBFD symbols on the non-reference cell.
Aspect 36: The method of any of Aspects 22-35, wherein a symbol is configured as an SBFD symbol on a non-reference cell and downlink control information (DCI) scheduling a downlink transmission on a reference cell is detected, and wherein the downlink transmission that is scheduled by the DCI is transmitted on the reference cell and a UE is not expected to transmit an uplink configured by radio resource control (RRC) in an uplink subband of SBFD symbols on the non-reference cell.
Aspect 37: The method of any of Aspects 22-36, wherein a symbol is configured as an SBFD symbol on a reference cell and downlink control information (DCI) scheduling an uplink transmission on a non-reference cell is detected, and wherein the uplink transmission that is scheduled by the DCI is transmitted on the non-reference cell based at least in part on a UE not being scheduled or configured with a downlink transmission on the reference cell.
Aspect 38: The method of any of Aspects 22-37, wherein a symbol is configured as an SBFD symbol on a reference cell and downlink control information (DCI) scheduling a downlink transmission on a non-reference cell is detected, and wherein the downlink transmission that is scheduled by the DCI is transmitted on the non-reference cell based at least in part on a UE not being scheduled or configured with an uplink transmission on the reference cell.
Aspect 39: The method of any of Aspects 22-38, wherein the collision handling is based at least in part on a collision that occurs between a downlink transmission in a cell and a valid random access channel occasion (RO) in an SBFD symbol in another cell.
Aspect 40: The method of any of Aspects 22-39, wherein the CA is an intra-band CA or an inter-band CA.
Aspect 41: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-40.
Aspect 42: An apparatus for wireless communication at a device, the apparatus comprising one or more memories and one or more processors coupled to the one or more memories, the one or more processors configured to cause the device to perform the method of one or more of Aspects 1-40.
Aspect 43: An apparatus for wireless communication, the apparatus comprising at least one means for performing the method of one or more of Aspects 1-40.
Aspect 44: A non-transitory computer-readable medium storing code for wireless communication, the code comprising instructions executable by one or more processors to perform the method of one or more of Aspects 1-40.
Aspect 45: A non-transitory computer-readable medium storing a set of instructions for wireless communication, the set of instructions comprising one or more instructions that, when executed by one or more processors of a device, cause the device to perform the method of one or more of Aspects 1-40.
Aspect 46: A device for wireless communication, the device comprising a processing system that includes one or more processors and one or more memories coupled with the one or more processors, the processing system configured to cause the device to perform the method of one or more of Aspects 1-40.
Aspect 47: An apparatus for wireless communication at a device, the apparatus comprising one or more memories and one or more processors coupled to the one or more memories, the one or more processors individually or collectively configured to cause the device to perform the method of one or more of Aspects 1-40.
Aspect 48: A device comprising a processing system that includes one or more processors and one or more code-storing memories coupled with the one or more processors, the processing system configured to cause the device to perform the method of one or more of Aspects 1-40.
Aspect 49: A device comprising a processing system that includes processor circuitry and code-storing memory circuitry, the processing system configured to cause the device to perform the method of one or more of Aspects 1-40.

It will be apparent that systems or methods described herein may be implemented in different forms of hardware or a combination of hardware and software. A component being configured to perform a function means that the component has a capability to perform the function, and does not require the function to be actually performed by the component, unless noted otherwise.

As used herein, the term “determine” or “determining” can encompass one or more of a wide variety of actions. For example, “determining” can include one or more of calculating, computing, processing, deriving, detecting, estimating, investigating, looking up, inferring, ascertaining, measuring, resolving, selecting, choosing, obtaining, identifying, interpreting, demodulating, decoding, reading, establishing, forming or generating, among other examples. In some such examples, determining can involve a processor performing some type of calculating, computing, deriving, estimating, inferring, ascertaining, resolving, predicting or other processing to obtain one or more numerical values, sets, elements or other information or results. In some other such examples, determining can involve a processor identifying, looking up, investigating or otherwise obtaining some type of value, set, element or other information or result from a table, a data structure, a database or other memory device or location. In some other such examples, determining can involve a processor identifying, interpreting, demodulating, decoding, detecting, reading or otherwise obtaining some type of value, set, element or other information or result signaled in, for example, a received wireless packet. In some other such examples, determining can involve a processor selecting or choosing one or more values, sets, elements or other information or results from a larger set of values, sets elements or other information or results. In some other such examples, determining can involve a processor performing a measurement, such as on a received signal.

As used herein, the articles “a” and “an” are intended to refer to one or more items and may be used interchangeably with “one or more” or “at least one.” As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. Additionally, as used herein, a phrase referring to “a” or “an” element refers to one or more of such elements acting individually or collectively to perform the recited function(s). Additionally, as used herein, a “set” can refer to one or more items, and a “subset” can refer to a whole set or less than the whole set, but not an empty set. “Set,” “group,” and similar terms are intended to include one or more items and may be used interchangeably with “one or more.” Furthermore, as used herein, the term “or” is intended to be interpreted in the inclusive sense (such as when referring to a series) and may be used interchangeably with “and/or,” unless otherwise explicitly indicated (for example, if used in conjunction with “either” or “only one of”). For example, “A or B” may include A only, B only, or a combination of A and B. Also, as used herein, the terms “has,” “have,” “having,” “comprise,” “comprising,” “include” and “including,” and derivatives thereof or similar terms are intended to be open-ended terms that do not limit an element that they modify (for example, an element “having” A also may have B).

As used herein, the phrase “associated with” is intended to be interpreted in the inclusive sense, unless otherwise explicitly indicated. For example, the phrase “associated with” is not to be construed as a reference to a closed set of conditions, factors, criteria, elements, components, or actions, among other examples. Specifically, unless a phrase refers to “associated with only ‘a,’” or the equivalent in context, whatever it is that is “associated with ‘a,’” may be associated with “a” alone or associated with a combination of “a” and one or more other conditions, factors, criteria, elements, components, or actions, among other examples. In various examples, the phrase “associated with” may be interpreted to mean “in association with,” “in accordance with,” “based on,” “based at least in part on,” “as a function of,” “in response to,” “responsive to,” or “using” as appropriate in the relevant context unless otherwise explicitly indicated. Furthermore, what follows the phrase “associated with,” “in association with,” “in accordance with,” “based on,” “based at least in part on,” “as a function of,” “in response to,” “responsive to,” or “using” is not necessarily the focal point or primary factor associated with the limitation preceding the phrase.

As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, configured to cause the UE to:
receive a configuration that indicates a plurality of component carriers (CCs) associated with carrier aggregation (CA), wherein the plurality of CCs includes a first CC associated with subband full duplex (SBFD) and a second CC associated with time division duplexing (TDD) or SBFD, and wherein the configuration is based at least in part on a UE capability support of a half-duplex mode among the plurality of CCs; and
perform a collision handling between a first transmission associated with the first CC and a second transmission associated with the second CC based at least in part on a set of collision handling rules.

2. The apparatus of claim 1, wherein performing the collision handling comprises:
transmitting the first transmission and dropping the second transmission based at least in part on the set of collision handling rules; or transmitting the second transmission and dropping the first transmission based at least in part on the set of collision handling rules, wherein:
the first transmission is an uplink transmission, the second transmission is a downlink transmission, and the second CC is associated with TDD or SBFD; or
the first transmission is a downlink transmission, the second transmission is an uplink transmission, and the second CC is associated with SBFD.

3. The apparatus of claim 1, wherein the plurality of CCs is associated with a reference cell and a non-reference cell, wherein the reference cell is an active cell with a lowest cell index among a plurality of cells associated with the plurality of CCs, and wherein a symbol associated with the reference cell is indicated as an SBFD symbol and is based at least in part on a configured uplink transmission or a configured downlink reception.

4. The apparatus of claim 3, wherein: the symbol is a downlink symbol based at least in part on the symbol being the SBFD symbol and the UE being configured to receive a downlink transmission on the symbol; or
the symbol is an uplink symbol based at least in part on the symbol being the SBFD symbol and the UE being configured to transmit an uplink transmission on the symbol.

5. The apparatus of claim 1, wherein the plurality of CCs is associated with a reference cell and a non-reference cell, wherein the reference cell is an active cell with a lowest cell index among a plurality of cells associated with the plurality of CCs, and wherein a symbol associated with the reference cell is a flexible symbol based at least in part on the symbol being an SBFD symbol.

6. The apparatus of claim 1, wherein the plurality of CCs is associated with a reference cell and a non-reference cell, wherein the non-reference cell is a TDD cell, and wherein the reference cell being associated with an SBFD symbol and the TDD cell being associated with an uplink symbol is an error case for intra-band CA.

7. The apparatus of claim 1, wherein the plurality of CCs is associated with a reference cell and a non-reference cell, wherein the non-reference cell is an SBFD cell, and wherein the reference cell being associated with an uplink symbol and the SBFD cell being associated with an SBFD symbol is an error case for intra-band CA.

8. The apparatus of claim 1, wherein the set of collision handling rules defines one or more UE behaviors based at least in part on collisions between radio resource control (RRC) based downlink or uplink symbols and SBFD symbols.

9. The apparatus of claim 1, wherein a symbol corresponds to a downlink transmission configured by radio resource control (RRC) on a reference cell and the symbol is indicated as an SBFD symbol on a non-reference cell, and wherein the collision handling includes treating the SBFD symbol as a flexible symbol, the collision handling includes treating the SBFD symbol as a downlink symbol, or the collision handling is based at least in part on whether an uplink scheduling in the SBFD symbol is configured by RRC or triggered dynamically by downlink control.

10. The apparatus of claim 1, wherein a symbol corresponds an uplink transmission configured by radio resource control (RRC) on a reference cell and the symbol is indicated as an SBFD symbol on a non-reference cell, and wherein the collision handling includes treating the SBFD symbol as a flexible symbol, the collision handling includes treating the SBFD symbol as an uplink symbol, or the collision handling is based at least in part on whether a downlink scheduling in the SBFD symbol is configured by RRC or triggered by downlink control.

11. The apparatus of claim 1, wherein a symbol is configured as an SBFD symbol on a reference cell and an radio resource control (RRC) based uplink transmission is configured on a non-reference cell, and wherein the collision handling includes dropping the RRC based uplink transmission based at least in part on the UE being configured to receive downlink in the SBFD symbol on the reference cell.

12. The apparatus of claim 1, wherein a symbol is configured as an SBFD symbol on a reference cell and an radio resource control (RRC) based downlink transmission is configured on a non-reference cell in the symbol, and wherein the collision handling includes dropping the RRC based downlink transmission based at least in part on the UE being configured to transmit uplink in the SBFD symbol on the reference cell.

13. The apparatus of claim 1, wherein a symbol is configured as an SBFD symbol on a non-reference cell and downlink control information (DCI) scheduling an uplink transmission on a reference cell is detected, and wherein the uplink transmission that is scheduled by the DCI is transmitted on the reference cell and the UE is not expected to receive a downlink configured by radio resource control (RRC) in a downlink subband of SBFD symbols on the non-reference cell.

14. The apparatus of claim 1, wherein a symbol is configured as an SBFD symbol on a non-reference cell and downlink control information (DCI) scheduling a downlink transmission on a reference cell is detected, and wherein the downlink transmission that is scheduled by the DCI is transmitted on the reference cell and the UE is not expected to transmit an uplink configured by radio resource control (RRC) in an uplink subband of SBFD symbols on the non-reference cell.

15. The apparatus of claim 1, wherein a symbol is configured as an SBFD symbol on a reference cell and downlink control information (DCI) scheduling an uplink transmission on a non-reference cell is detected, and wherein the uplink transmission that is scheduled by the DCI is transmitted on the non-reference cell based at least in part on the UE not being scheduled or configured with a downlink transmission on the reference cell.

16. The apparatus of claim 1, wherein a symbol is configured as an SBFD symbol on a reference cell and downlink control information (DCI) scheduling a downlink transmission on a non-reference cell is detected, and wherein the downlink transmission that is scheduled by the DCI is transmitted on the non-reference cell based at least in part on the UE not being scheduled or configured with an uplink transmission on the reference cell.

17. The apparatus of claim 1, wherein performing the collision handling is based at least in part on a collision that occurs between a downlink transmission in a cell and a valid random access channel occasion (RO) in an SBFD symbol in a another cell.

18. The apparatus of claim 1, wherein the CA is an intra-band CA or an inter-band CA, and wherein the UE is a half-duplex CA UE.

19. An apparatus for wireless communication at a network node, comprising:
one or more memories; and
one or more processors, coupled to the one or more memories, configured to cause the network node to:
transmit a configuration that indicates a plurality of component carriers (CCs) associated with carrier aggregation (CA), wherein the plurality of CCs includes a first CC associated with subband full duplex (SBFD) and a second CC associated with time division duplexing (TDD) or SBFD, and wherein the configuration is based at least in part on a user equipment (UE) capability support of a half-duplex mode among the plurality of CCs; and
detect a collision handling between a first transmission associated with the first CC and a second transmission associated with the second CC based at least in part on a set of collision handling rules.

20. A method of wireless communication performed by a user equipment (UE), comprising:
receiving a configuration that indicates a plurality of component carriers (CCs) associated with carrier aggregation (CA), wherein the plurality of CCs includes a first CC associated with subband full duplex (SBFD) and a second CC associated with time division duplexing (TDD) or SBFD, and wherein the configuration is based at least in part on a UE capability support of a half-duplex mode among the plurality of CCs; and
performing a collision handling between a first transmission associated with the first CC and a second transmission associated with the second CC based at least in part on a set of collision handling rules.
